(19) United States
(12) Patent Application Publication
(10) Pub. No.: US 2006/0033745 A1
(43) Pub. Date: Feb. 16, 2006

(54) Graphics engine with edge draw unit, and electrical device and memopry incorporating the graphics engine

(76) Inventors: Metod Koselj, Dusseldorf (DE); Mika Tuomi, Soormarkku (FI)

Correspondence Address: STITES & HARBISON PLLC, 1199 NORTH FAIRFAX STREET, SUITE 900, ALEXANDRIA, VA, 22314, US

(21) Appl. No.: 10/513,352

(22) PCT Filed: May 9, 2003
(86) PCT No.: PCT/IB03/02315

§ 371 Date: Jun. 21, 2005

Related U.S. Application Data
(63) Continuation-in-part of application No. 10/141,797, filed on May 10, 2002.

(30) Foreign Application Priority Data
May 10, 2002 (GB) 0210764.7

(51) Int. Cl. G06F 13/14

(52) U.S. Cl. 345/519

(57) ABSTRACT

The invention provides a graphics engine for rendering image data for display pixels in dependence upon received high-level graphics commands defining polygons including an edge draw unit to read in a command phrase of the language corresponding to a single polygon edge and convert the command to a spatial representation of the edge based on that command phrase. An electrical device incorporating the graphics engine and a memory integrated circuit having an embedded graphics engine are also provided.

The present invention relates to a graphics engine, and an electrical device and memory incorporating the graphics engine.

The invention finds application in displays for electrical devices; notably in small-area displays found on portable or console electrical devices. Numerous such devices exist, such as PDAs, cordless, mobile and desk telephones, in-car information consoles, hand-held electronic games sets, multifunction watches etc.

In the prior art, there is typically a main CPU, which can generate commands and has the task of receiving display commands, processing them and sending the results to the display module in a pixel-data form describing the properties of each display pixel. The amount of data sent to the display module is proportional to the display resolution and the colour depth. For example, a small monochrome display of 96×96 pixels with a four level grey scale requires a fairly small amount of data to be transferred to the display module. Such a screen does not, however, meet user demand for increasingly attractive and informative displays.

With the demand for colour displays and for sophisticated graphics requiring higher screen resolution, the amount of data to be processed by the CPU and sent to the display module has become much greater. More complex graphics processing places a heavy strain on the CPU and slows the device, so that display reaction and refresh rate may become unacceptable. This is especially problematic for games applications. Another problem is the power drain caused by increased graphics processing, which can substantially shorten the intervals between recharging of battery-powered devices.

The problem of displaying sophisticated graphics at an acceptable speed is often solved by a hardware graphics engine (also known as a graphics accelerator) on an extra card that is housed in the processor box or as an embedded unit on the motherboard. The graphics engine takes over at least some of the display command processing from the main CPU. Graphics engines are specially developed for graphics processing, so that they are faster and uses less power than the CPU for the same graphics tasks. The resultant video data is then sent from the processor box to a separate “dumb” display module.

Known graphics engines used in PCs are specially conceived for large-area displays and are thus highly complex systems requiring separate silicon dies for the high number of gates used. It is impractical to incorporate these engines into portable devices, which have small-area displays and in which size and weight are strictly limited, and which have limited power resources.

Moreover, PC graphics engines are designed to process the types of data used in large-area displays, such as multiple bitmaps of complex images. Data sent to mobile and small-area displays may today be in vector graphics form. Examples of vector graphics languages are MacroMediaFlash™ and SVG™. Vector graphics definitions are also used for many gaming Application Programming Interfaces (APIs), for example Microsoft DirectX and OpenGL.

In vector graphics images are defined as multiple complex polygons. This makes vector graphics suited to images that can be easily defined by mathematical functions, such as game screens, text and GPS navigation maps. For such images, vector graphics is considerably more efficient than an equivalent bitmap. That is, a vector graphics file defining the same detail (in terms of complex polygons) as a bitmap file (in terms of each individual display pixel) will contain fewer bytes. The conversion of the vector graphics file into a steam of coordinates of the pixels (or sub-pixels) inside the polygon to form a bitmap is known generally as “rasterisation”. The bitmap file is the finished image data in pixel format, which can be copied directly to the display.

A complex polygon is a polygon that can self-intersect and have “holes” in it. Examples of complex polygons are letters and numerals such as “X” and “8” and kanji characters. Vector graphics is, of course, also suitable for definition of the simple polygons such as the triangles that make up the basic primitive for many computer games. The polygon is defined by straight or curved edges and fill commands. In theory there is no limit to the number of edges of each polygon. However, a vector graphics file containing, for instance, a photograph of a complex scene will contain several times more bytes than the equivalent bitmap.

Graphics processing algorithms are also known that are suitable for use with the high-level/vector graphics languages employed, for example, with small-area displays. Some algorithms are available, for example, in “Computer Graphics: Principles and Practice” Foley, Van Damn, Feiner, Hughes 1996 Edition, ISBN 0-201-84840-6.

The graphics engines are usually software graphics algorithms employing internal dynamic data structures with linked lists and sort operations. All the vector graphics commands giving polygon edge data for one polygon must be read into the software engine and stored in a data structure before it starts rendering (generating an image for display from the high-level commands received). The commands for each polygon are, for example, stored in a master list of start and end points for each polygon edge. The polygon is drawn (rasterised) scanline by scanline. For each scanline of the display the software first checks through the list (or at least through the parts of the list likely to be relevant to the scanline selected) and selects which polygon edges (“active edges”) cross the scanline. It then identifies where each selected edge crosses the scanline and sorts them (typically left to right) so that the crossings are labelled 1, 2, 3 . . . from the left of the display area. Once the crossing points have been sorted, the polygon can be filled between them (for example, using an odd/even rule that starts filling at odd crossings and discontinues at the next (even) crossing.

Each vertex requires storage for x and y. Typically these are 32 bit floating point values. For an “n” sided polygon, the maximum storage required is “n” multiplied by the number of vertices, which is an unknown. Thus, the size of the master list that can be processed is limited by the amount of memory available in the software. The known software algorithms thus suffer from the disadvantage that they require a large amount of memory to store all the commands for complex polygons before rendering. This makes them difficult to convert to hardware and may also prejudice manufacturers against incorporating vector graphics processing in mobile devices.

Hardware graphics engines are more likely to use triangle rasteriser circuitry that divides each polygon into triangles (or less commonly, trapezoids), processes each triangle separately to produce filled pixels for that triangle, and then recombines the processed triangles to render the whole polygon. Although the division into triangles can be performed in hardware or software, the subsequent rendering is nearly always in hardware.

This technique is sometimes known as triangulation (or triangle tessellation) and is the conventional way of rendering 2d and 3d objects used in most graphics hardware today.

The geometry for each triangle is read in and the rasterisation generates the pixel coordinates for all pixels within the triangle. Typically pixel coordinates are output line by line, but other sequences are also used.

Since the geometry information required for rasterisation for each triangle is fixed (3 vertices for x and y), there is no storage problem in implementing this in hardware.

In fact, the memory required for the vertices can be of arbitrary size; for example, there may be colour and other information for each vertex. However, such information is not required for rasterisation so the data required for rasterisation is fixed.

Nevertheless, triangulation may not be easy for more complex polygons, especially those which self-intersect, because then the entire complex polygon must be input and stored before triangulation, to avoid filling pixels which later become “holes. Evidently, a plurality of (if not all) edges are required anyway before processing of even simple convex polygons starts, to show which side of the edge is to be filled. One way of implementing this is to wait for the “fill” command, which follows definition of all the edges in a polygon, before starting triangulation.

It is desirable to overcome the disadvantages inherent in the prior art and lessen the CPU load and/or data traffic for display purposes in portable electrical devices.

The invention is defined in the independent claims, to which reference should now be made. Advantageous features are defined in the dependent claims.

According to one embodiment of the invention there is provided a graphics engine for rendering image data for display pixels in dependence upon received high-level graphics commands defining polygons including: an edge draw unit to read in a command phrase of the language corresponding to a single polygon edge and convert the command to a spatial representation of the edge based on that command phrase.

Thus, the graphics engine of preferred embodiments includes control circuitry/logic to read in one high-level graphics (e.g. vector graphics) command at a time and convert the command to a spatial representation (that is, draw the edge). It may also read and convert a plurality of lives simultaneously, if it works in parallel, or a plurality of edge draw units may be provided.

Reference herein to a command or command phrase does not necessarily imply a single command line but includes all command lines required to define a part of a polygon (such as an edge or colour).

There are several specific advantages of the logical construction of the graphics engine. One advantage is that it does not require memory to hold a polygon edge once it has been read into the engine. Considerable memory and power savings are achievable, making the graphics engine particularly suitable for use with portable electrical devices, but also useful for larger electrical devices, which are not necessarily portable.

Furthermore, the simple conversion to spatial information when a command is read allows a smaller logical construction of the graphics engine than that possible in the prior art so that the gates in a hardware version and processing requirements for a software version as well as memory required for rendering can be significantly reduced.

The graphics engine may discard the original command before processing the next command. Of course, if the edge drawing unit works in parallel, the next command need not be the subsequent command in the command string, but could be the next available command.

Preferably, the edge draw unit reads in a command phrase (corresponding to a valid or directly displayable edge) and immediately converts any valid edge into a spatial representation.

This allows the command or command phrase to be deleted as soon as possible. Preferably, intermediate processing is required only to convert (invalid) lines that should not be processed (such as those outside a viewing area) or cannot be processed (such as curves) to a valid format that can be rendered by the graphics engine.

Advantageously, the spatial representation is based on that command phrase alone, except where the polygon edge overlaps edges previously or simultaneously read and converted. Clearly, overlapping edges produce a different outcome and this avoids any incorrect display data, which might otherwise appear.

In preferred embodiments, the spatial representation of the edge is in a sub-pixel format, allowing later recombination into display pixels. This corresponds to the addressing often used in the command language, which has higher than screen definition.

The provision of sub-pixels (more than one for each corresponding pixel of the display) also facilitates manipulation of the data and anti-aliasing in an expanded spatial form, before consolidation into the display size. The number of sub-pixels per corresponding display pixel determines the degree of anti-aliasing available.

Advantageously, the spatial representation defines the position of the final display pixels. Thus, where an edge has been drawn, generally pixels corresponding to sub-pixels within the edges correspond to final display pixels for the filled polygon. This has clear advantages in reduced processing.

Preferably, the graphics engine further comprises an edge buffer for storage of the spatial representation.

Thus, in preferred embodiments, the graphics engine includes edge drawing logic/circuitry linked to an edge buffer (of finite resolution) to store spatial information for (the edges of) any polygon read into the engine. The edge buffer arrangement not only makes it possible to discard the original data for each edge easily once it has been read into the buffer, in contrast to the previous software engine. It also has the advantage that it imposes no limit on the complexity of the polygon to be drawn, as may be the case with the prior art linked list storage of the high-level commands.

The edge buffer may be of higher resolution than the front buffer of the display memory. For example, the edge buffer may be arranged to store sub-pixels as previously mentioned, a plurality of sub-pixels corresponding to a single display pixel.

The edge buffer may be in the form of a grid and the individual grid squares or sub-pixels preferably switch between the set and unset states to store the spatial information. Use of unset and set states only mean that the edge buffer requires one bit of memory per sub-pixel.

Preferably, the edge buffer stores each polygon edge as boundary sub-pixels which are set and whose positions in the edge buffer relate to the edge position in the final image.

Advantageously, graphics engine according to any of the preceding claims wherein the input and conversion of single polygon edges allows rendering of polygons without triangulation and also allows rendering of a polygon to begin before all the edge data for the polygon has been acquired.

The graphics engine may include filler circuitry/logic to fill in polygons whose edges have been stored in the edge buffer. This two-pass method has the advantage of simplicity in that the 1 bit per sub-pixel (edge buffer) format is re-used before the color of the filled polygon is produced. The resultant set sub-pixels need not be re-stored in the edge buffer but can be used directly in the next steps of the process.

The graphics engine preferably includes a back buffer to store part or all of an image before transfer to a front buffer of the display driver memory. Use of a back buffer avoids rendering directly to the front buffer and can prevent flicker in the display image.

The back buffer is preferably of the same resolution as the front buffer of the display memory. That is, each pixel in the back buffer is mapped to a corresponding pixel of the front buffer. The back buffer preferably has the same number of bits per pixel as the front buffer to represent the colour and depth (RGBA values) of the pixel.

There may be combination logic/circuitry provided to combine each filled polygon produced by the filler circuitry into the back buffer. The combination may be sequential or be produced in parallel. In this way the image is built up polygon by polygon in the back buffer before transfer to the front buffer for display.

Advantageously, the colour of each pixel stored in the back buffer is determined in dependence on the colour of the pixel in the polygon being processed, the percentage of the pixel covered by the polygon and the colour already present in the corresponding pixel in the back buffer. This colour-blending step is suitable for anti-aliasing.

In one preferred implementation, the edge buffer stores sub-pixels in the form of a grid having a square number of sub-pixels for each display pixel. For example, a grid of 4×4 sub-pixels in the edge buffer may correspond to one display pixel. Each sub-pixel is set or unset depending on the edges to be drawn.

In an alternative embodiment, every other sub-pixel in the edge buffer is not utilised, so that half the square number of sub-pixels is provided per display pixel (a “chequerboard” pattern). In this embodiment, if the edge-drawing circuitry requires that a non-utilised sub-pixel be set, the neighbouring (utilised) sub-pixel is set in its place. This alternative embodiment has the advantage of requiring fewer bits in the edge buffer per display pixel, but lowers the quality of antialiasing somewhat.

The slope of each polygon edge may be calculated from the edge end points and then sub-pixels of the grid set along the line. Preferably, the following rules are used for setting sub-pixels:
one sub-pixel only per horizontal line of the sub-pixel grid is set for each polygon edge;
the sub-pixels are set from top to bottom (in the Y direction);
the last sub-pixel of the line is not set;
any sub-pixels set under the line are inverted.

In this implementation, the filler circuitry may include logic/code acting as a virtual pen (sub-pixel state-setting filler) traversing the sub-pixel grid, which pen is initially off and toggles between the off and on states each time it encounters a set sub-pixel. The resultant data is preferably fed to amalgamation circuitry combining the sub-pixels corresponding to each pixel.

The virtual pen preferably sets all sub-pixels inside the boundary sub-pixels, and includes boundary pixels for right-hand boundaries, and clears boundary pixels for left-hand boundaries or vice versa. This avoids overlapping sub-pixels for polygons that do not mathematically overlap. The virtual pen may cover a line of sub-pixels (to process them in parallel) and fill a plurality of sub-pixels simultaneously.

Preferably, the virtual pen's traverse is limited so that it does not need to consider sub-pixels outside the polygon edge. For example, a bounding box enclosing the polygon may be provided.

The sub-pixels (from the filler circuitry) corresponding to a single display pixel are preferably amalgamated into a single pixel before combination to the back buffer. Amalgamation allows the back buffer to be of lower resolution than the edge buffer (data is held per pixel rather than per sub-pixel), thus reducing memory requirement. Of course the data held for each location in the edge buffer is minimal as explained above (one bit per sub-pixel) whereas the back buffer holds color values (say 16 bits) for each pixel.

Combination circuitry/logic may be provided for combination to the back buffer, the number of sub-pixels of each amalgamated pixel covered by the filled polygon determining a blending factor for combination of the amalgamated pixel into the back buffer.

The back buffer is copied to the front buffer of the display memory once the image on the part of the display for which it holds information has been entirely rendered. In fact, the back buffer may be of the same size as the front buffer and hold information for the whole display. Alternatively, the back buffer may be smaller than the front buffer and store the information for part of the display only, the image in the front buffer being built from the back buffer in a series of external passes.

In this latter alternative, the process is shortened if only commands relevant to the part of the image to be held in the back buffer are sent to the graphics engine in each external pass (to the CPU).

The graphics engine may be provided with various extra features to enhance its performance.

The graphics engine may further include a curve tessellator to divide any curved polygon edges into straight-line segments and store the resultant segments in the edge buffer.

The graphics engine may be adapted so that the back buffer holds one or more graphics (predetermined image elements) which are transferred to the front buffer at one or more locations determined by the high level language. The graphics may be still or moving images (sprites), or even text letters.

The graphics engine may be provided with a hairline mode, wherein hairlines are stored in the edge buffer by setting sub-pixels in a bitmap and storing the bitmap in multiple locations in the edge buffer to form a line. Such hairlines define lines of one pixel depth and are often used for drawing polygon silhouettes.

Preferably, the edge draw unit can work in parallel to convert a plurality of command phrases simultaneously to spatial representation.

As another improvement, the graphics engine may include a clipper unit which processes any part of a polygon edge outside a desired screen viewing area before reading and converting the resultant processed polygon edges within the screen viewing area. This allows any invalid lines to be deleted without a producing a spatial representation.

Preferably, the clipper unit deletes all edges outside the desired screen viewing area except where the edge is required to define the start of polygon filling, in which case the edge is diverted to coincide with the relevant viewing area boundary.

As a further improvement to the design, the edge draw unit may include a blocking and/or bounding unit, which reduces memory usage by grouping the spatial representation into blocks of data and/or creating a bounding box corresponding to the polygon being rendered, outside of which no data is subsequently read.

The graphics engine may be implemented in hardware and is preferably less than 100 K gates in size and more preferably less than 50 K in this case.

The graphics engine need not be implemented in hardware, but may alternatively be a software graphics engine. In this case the necessary coded logic could be held in the CPU, along with sufficient code/memory for any of the preferred features detailed above, if they are required. Where circuitry is referred to above, the skilled person will readily appreciate that the same function is available in a code section of a software implementation. For example, the graphics engine may be implemented in software to be run on a processor module of an electrical device with a display.

The graphics engine may be a program, preferably held in a processing unit, or may be a record on a carrier or take the form of a signal.

According to a further embodiment of the invention there is provided an electrical device including: a graphics engine as previously described; a display module; a processor module; and a memory module, in which high-level graphics commands are sent to the graphics engine to render image data for display pixels.

Thus, embodiments of the invention allow a portable electrical device to be provided with a display that is capable of displaying images from vector graphics commands whilst maintaining fast display refresh and response times and long battery life.

The electrical device may be portable and/or have a small-area display. These are areas of important application for a simple graphics engine with reduced power and memory requirements as described herein.

Reference herein to small-area displays includes displays of a size intended for use in portable electrical devices and excludes, for example, displays used for PCS.

Reference herein to portable devices includes hand-held, worn, pocket and console devices etc that are sufficiently small and light to be carried by the user. The graphics engine may be a hardware graphics engine embedded in the memory module or alternatively integrated in the display module.

The graphics engine may be a hardware graphics engine attached to a bus in a unified or shared memory architecture or held within a processor module or on a baseband or companion IC including a processor module.

According to a further embodiment of the invention there is provided a memory IC (integrated circuit) containing an embedded hardware graphics engine, wherein the graphics engine uses the standard memory IC physical interface and makes use of previously unallocated command space for graphics processing. Preferably, the graphics engine is as previously described.

Memory ICs (or chips) often have unallocated commands and pads, because they are designed to a general standard, rather than for specific applications. Due to its inventive construction, the graphics engine can be provided in a small number of gates in its hardware version, which for the first time allows integration of a graphics engine within spare memory space of a standard memory chip, and also without changing the physical interface (pads).

Preferred features of the present invention will now be described, purely by way of example, with reference to the accompanying drawings, in which:

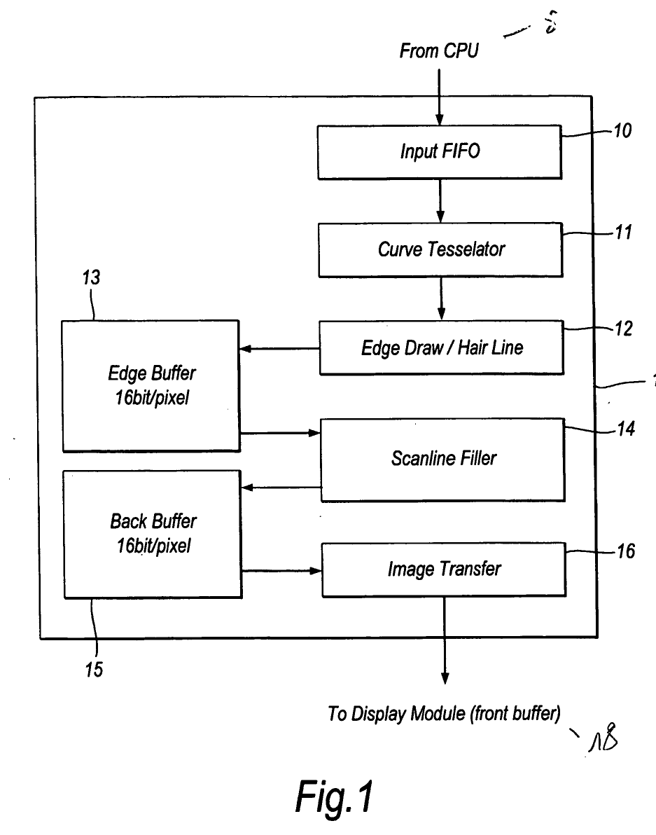

FIG. 1 is a block diagram representing function blocks of a preferred graphics engine

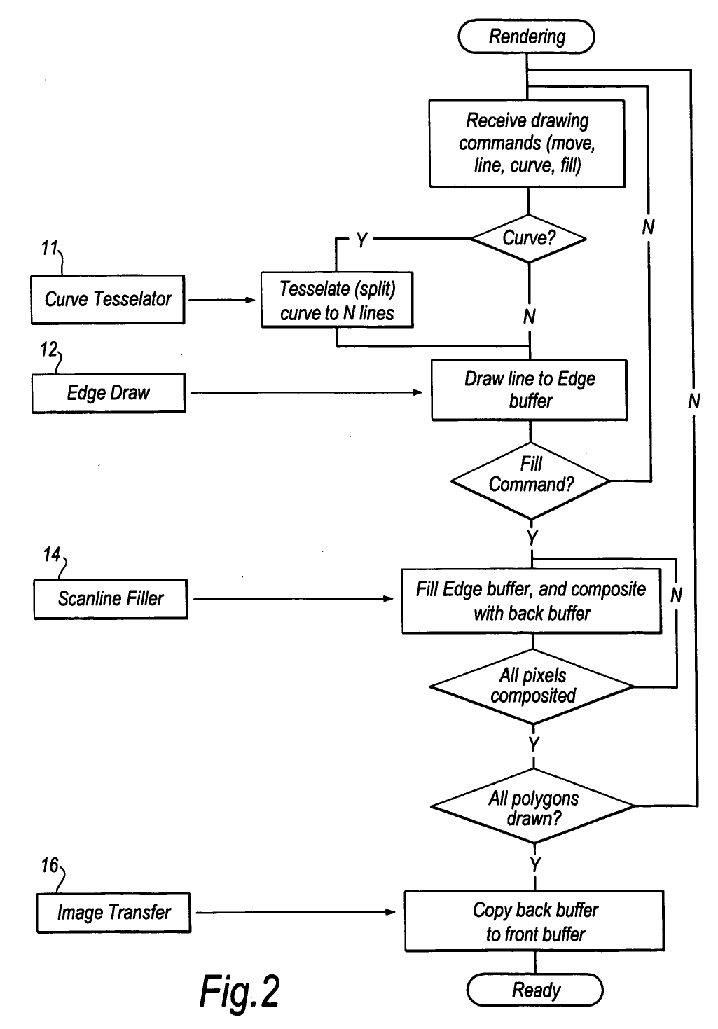

FIG. 2 is a flow chart illustrating operation of a preferred graphics engine;

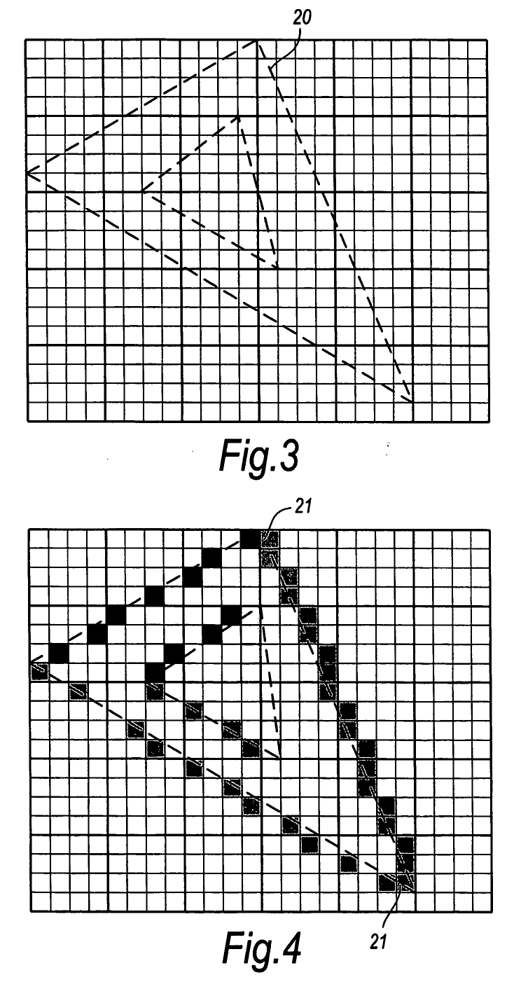

FIG. 3 is a schematic of an edge buffer showing the edges of a polygon to be drawn and the drawing commands that result in the polygon;

FIG. 4 is a schematic of an edge buffer showing sub-pixels set for each edge command;

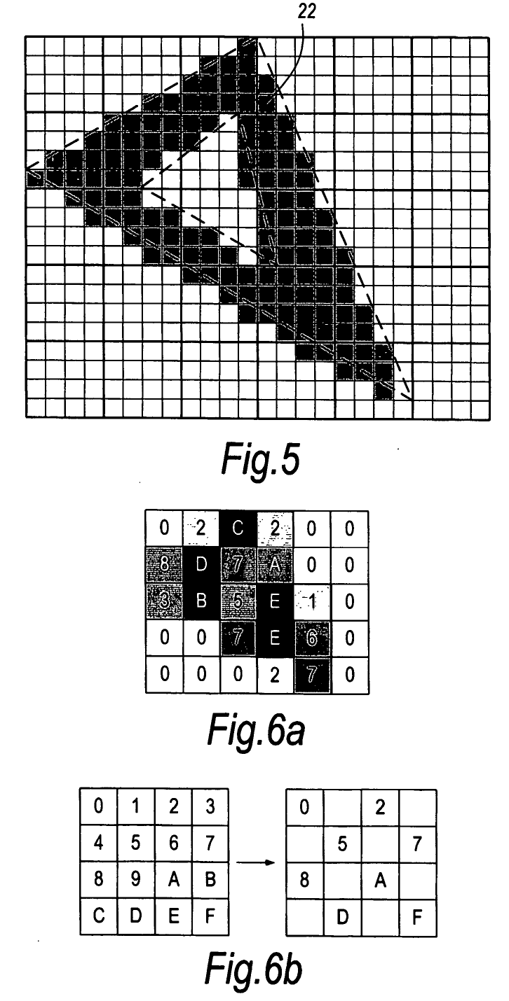

FIG. 5 is a schematic of an edge buffer showing a filled polygon;

FIG. 6a is a schematic of the amalgamated pixel view of the filled polygon shown in FIG. 5;

FIG. 6b is a schematic of an edge buffer layout with reduced memory requirements.

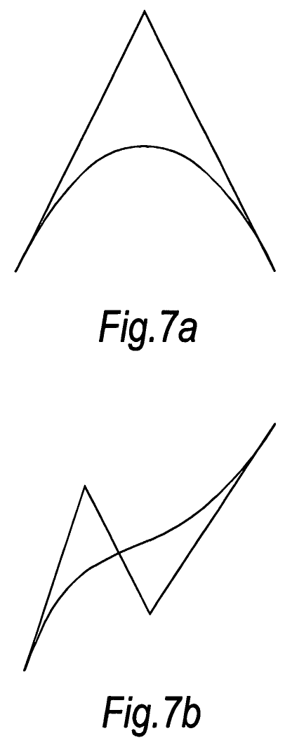

FIGS. 7a and 7b show a quadratic and a cubic bezier curve respectively;

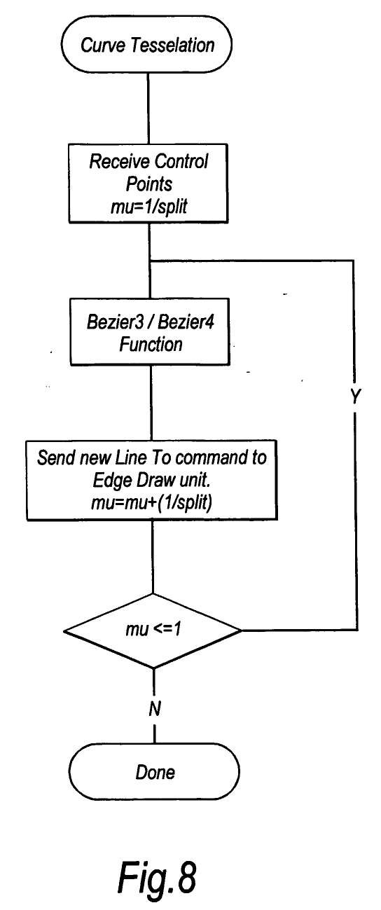

FIG. 8 shows a curve tessellation process according to an embodiment of the invention;

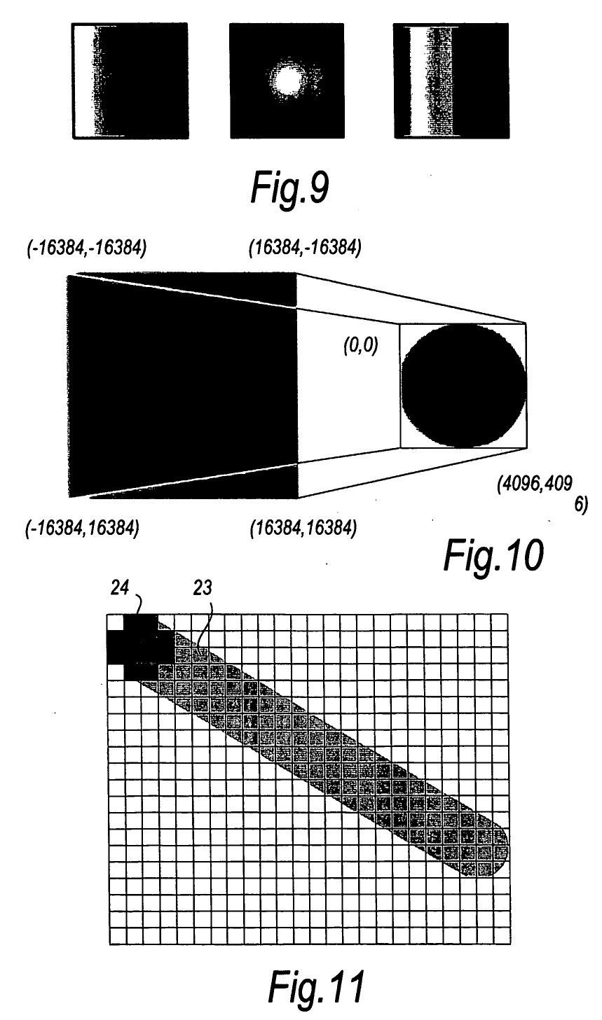

FIG. 9 gives four examples of linear and radial gradients;

FIG. 10 shows a standard gradient square;

FIG. 11 shows a hairline to be drawn in the edge buffer;

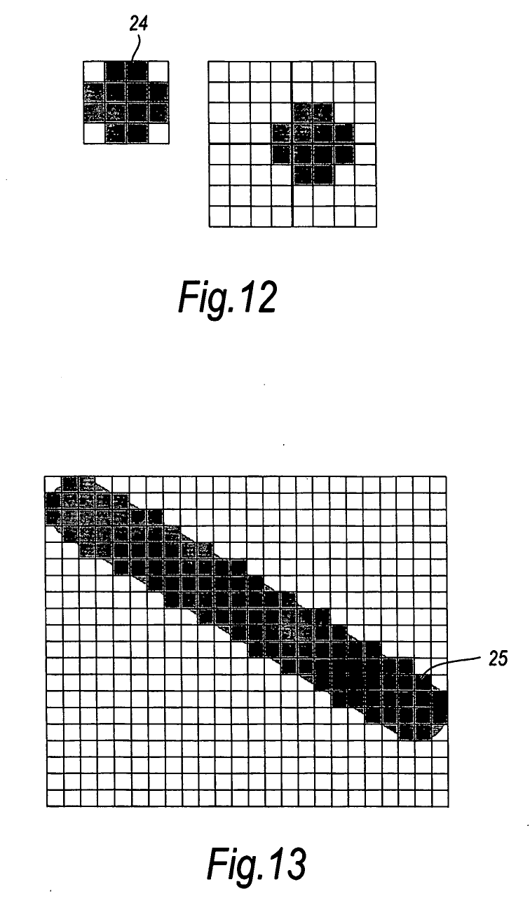

FIG. 12 shows the original circle shape to draw a hairline in the edge buffer, and its shifted position;

FIG. 13 shows the final content of the edge buffer when a hairline has been drawn;

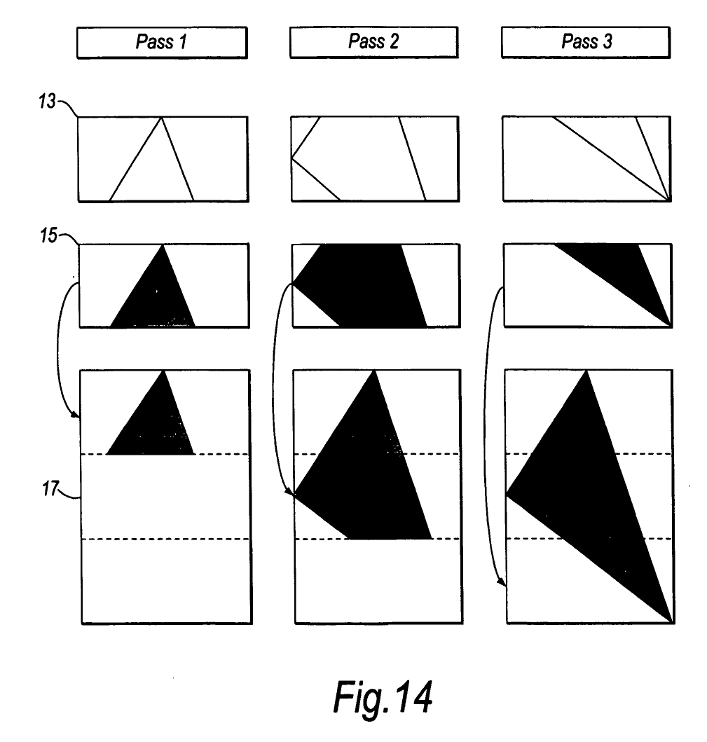

FIG. 14 shows a sequence demonstrating the contents of the edge, back and front buffers in which the back buffer holds ⅓ of the display image in each pass;

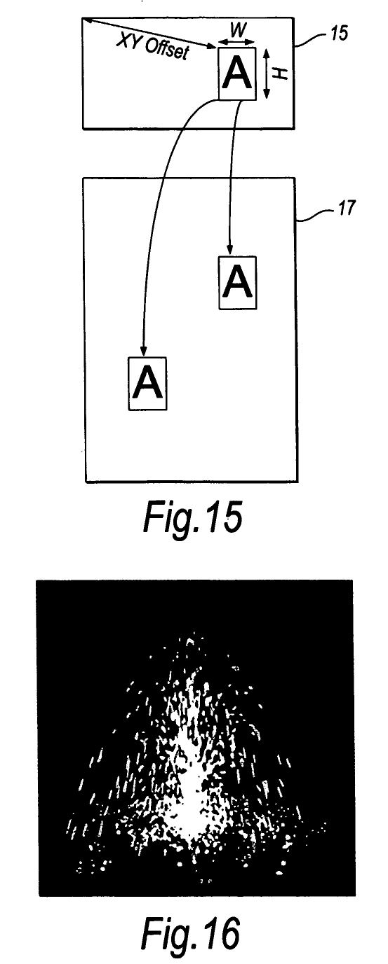

FIG. 15 shows one sprite in the back buffer copied to two locations in the front buffer,

FIG. 16 shows an example in which hundreds of small 2D sprites are rendered to simulate spray of small particles;

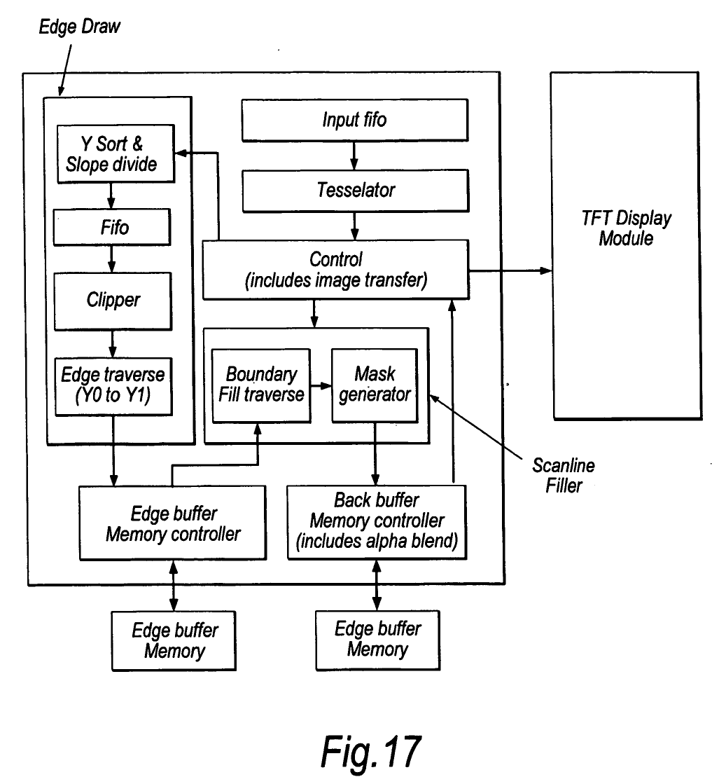

FIG. 17 shows a generalised hardware implementation for the graphics engine;

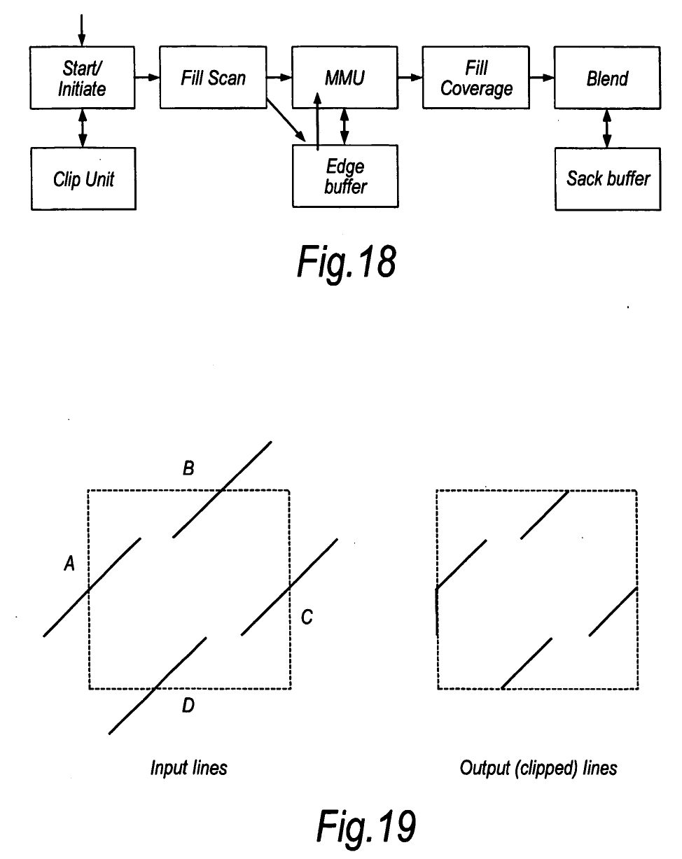

FIG. 18 shows some blocks of a specific hardware implementation for the graphics engine;

FIG. 19 shows the function of a clipping unit in the implementation of FIG. 18;

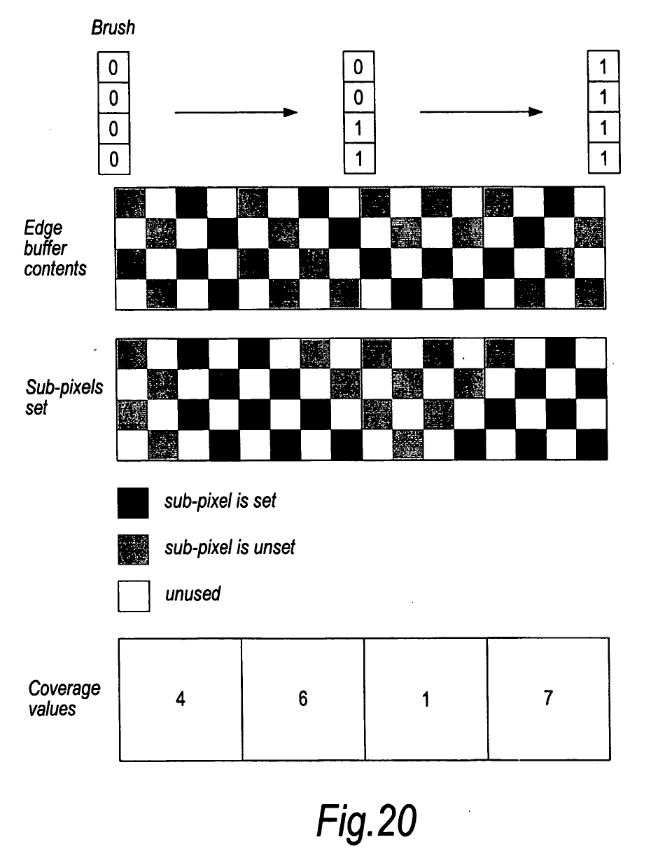

FIG. 20 shows the function of a brush unit in the implementation of FIG. 18;

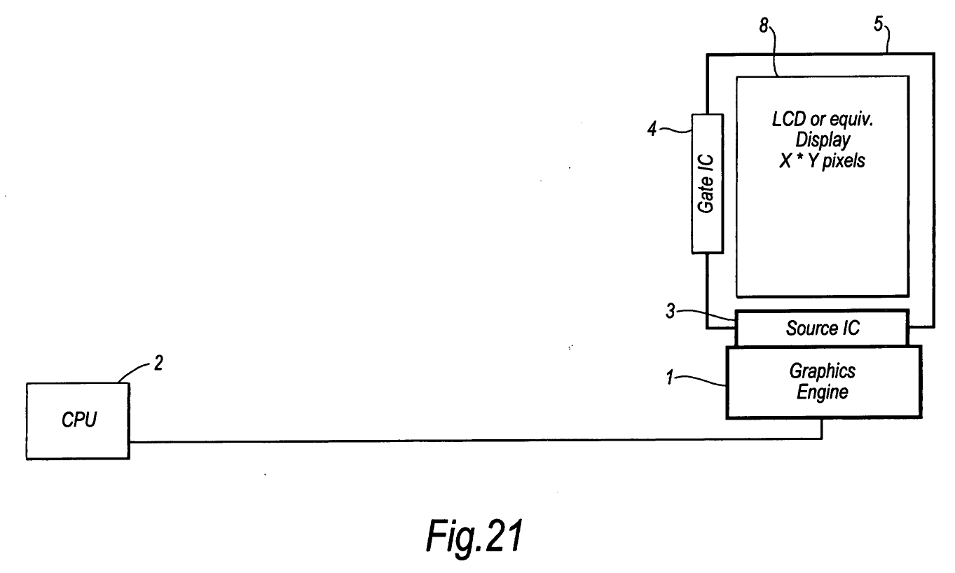

FIG. 21 is a schematic representation of a graphics engine according to an embodiment of the invention integrated in a source IC for an LCD or equivalent type display;

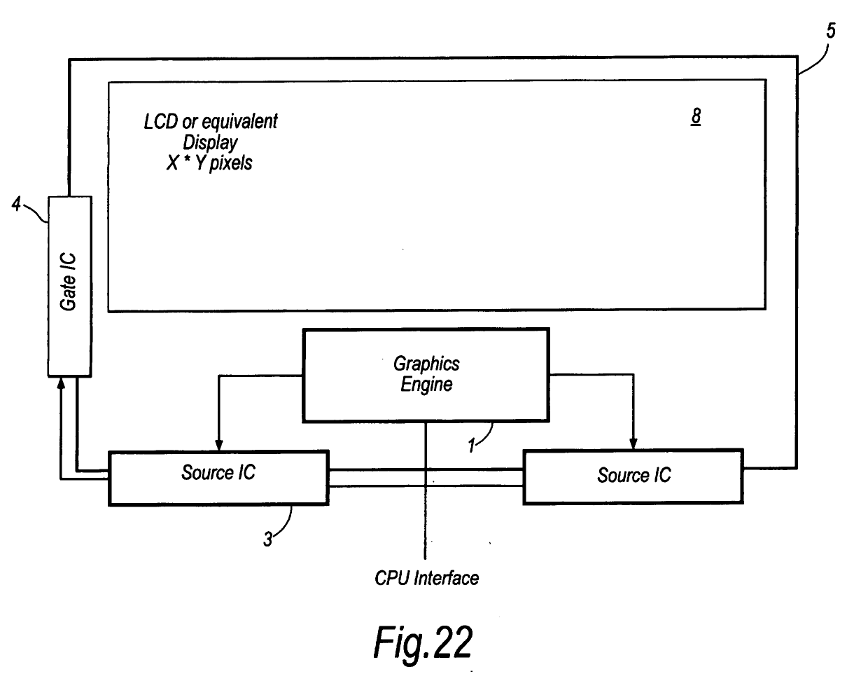

FIG. 22 is a schematic representation of a graphics engine according to an embodiment of the invention integrated in a display module and serving two source ICs for an LCD or equivalent type display;

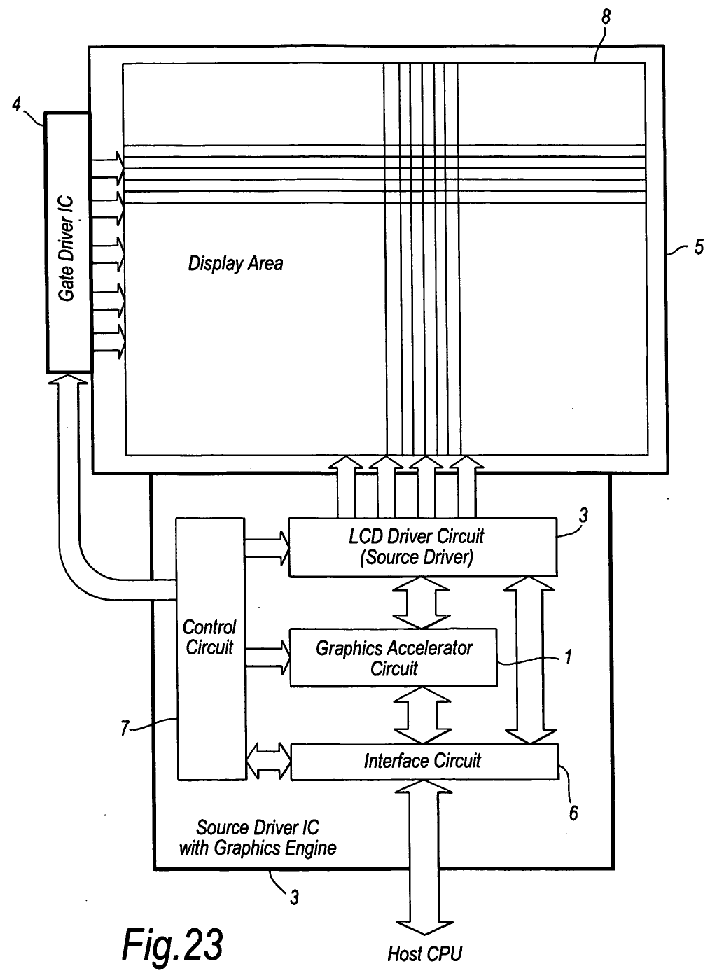

FIG. 23 is a schematic representation of a source driver IC incorporating a graphics engine and its links to CPU, the display area and a gate driver IC;

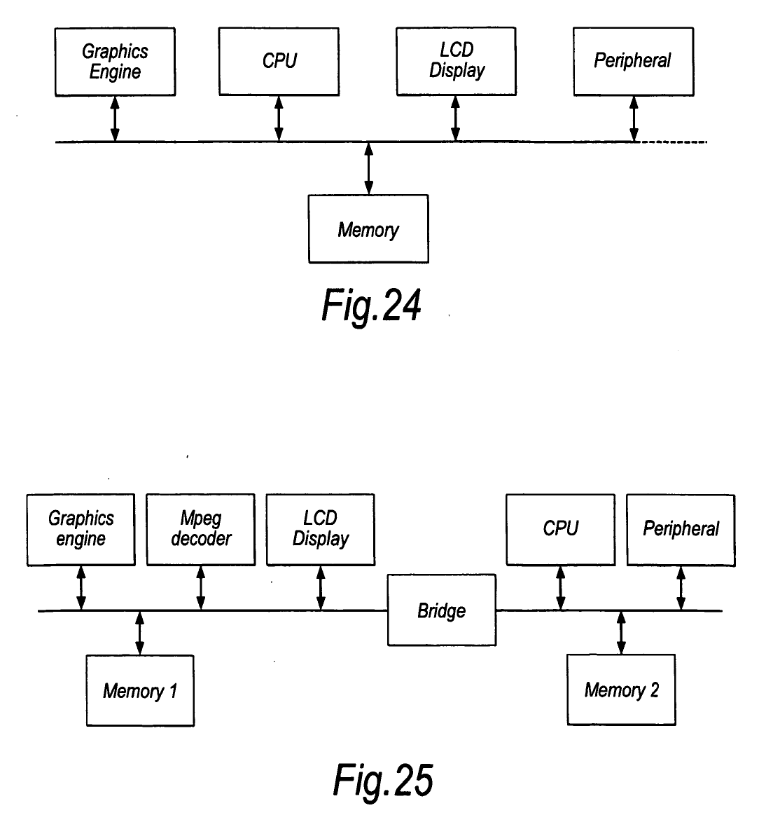

FIG. 24 is a schematic representation of a graphics engine using unified memory on a common bus;

FIG. 25 is a schematic representation of a graphics engine using shared memory on a common bus;

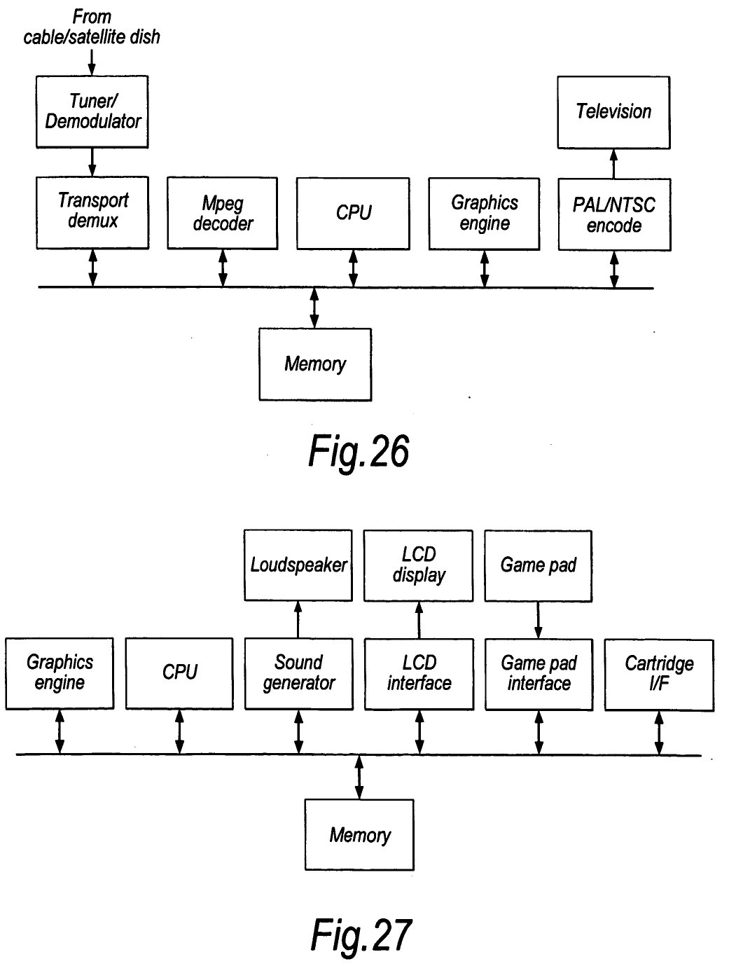

FIG. 26 is a schematic representation of a graphics engine using unified memory in a set-top box application;

FIG. 27 is a schematic representation of a graphics engine included in a games console architecture;

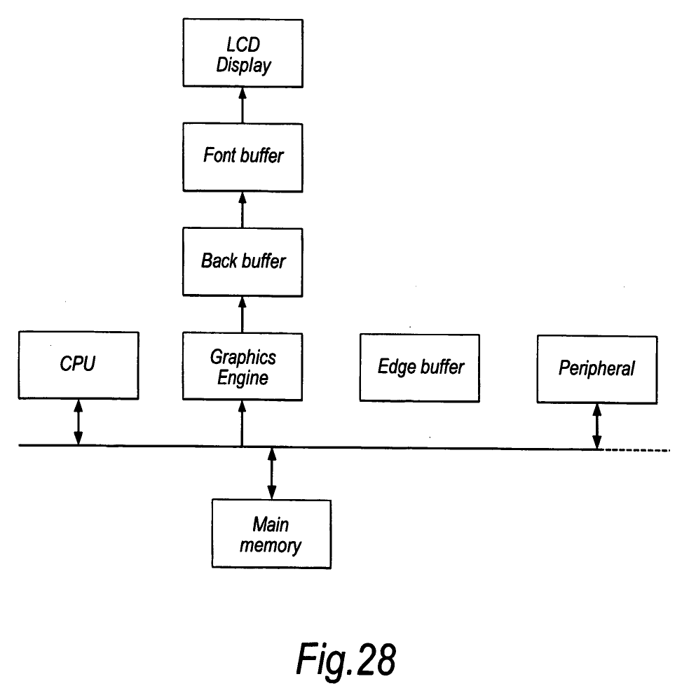

FIG. 28 is a schematic representation of a graphics engine with integrated buffers;

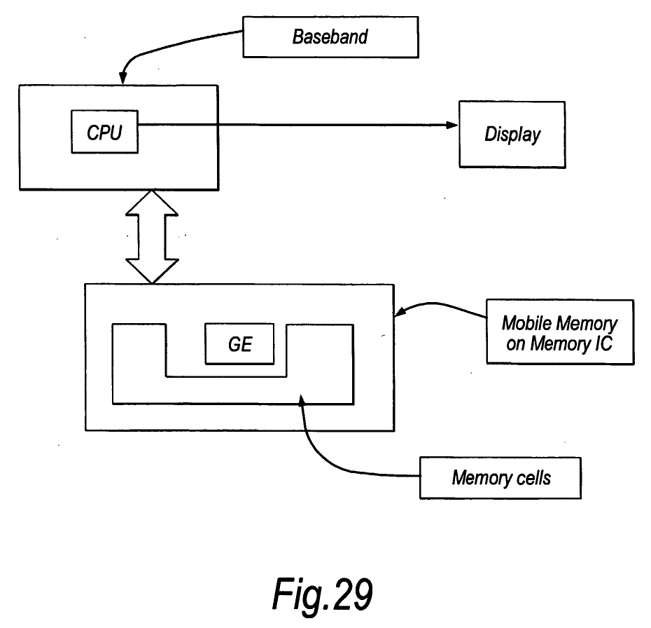

FIG. 29 is a schematic representation of a graphics engine embedded within memory.

Functional Overview

The function boxes in FIG. 1 illustrate the major logic gate blocks of an exemplary graphics engine 1. The vector graphics command are fed through the input/output section 10 initially to a curve tessellator 11, which divides any curved edges into straight-line segments. The information passes through to an edge and hairline draw logic block 12 that stores results in an edge buffer 13, which, in this case has 16 bits per display pixel. The edge buffer information is fed to the scanline filler 14 section to fill-in polygons as required by the fill commands of the vector graphics language. The filled polygon information is transferred to the back buffer 15 (in this case, again 16 bits per display pixel), which, in its turn relays the image to an image transfer block 16 for transfer to the front buffer.

The flow chart shown in FIG. 2 outlines the full rendering process for filled polygons. The polygon edge definition data comes into the engine one edge (in the form of one line or curve) at a time. The command language typically defines the image from back to front, so that polygons in the background of the image are defined (and thus read) before polygons in the foreground. If there is a curve it is tessellated before the edge is stored in the edge buffer. Once the edge has been stored, the command to draw the edge is discarded.

In vector graphics, all the edges of a polygon are defined by commands such as “move”, “line” and “curve” commands before the polygon is filled. Thus the tessellation and line drawing loop of embodiments of the invention is repeated (in what is known as a first pass) until a fill command is read. The process then moves onto filling the polygon colour in the edge buffer format. This is known as the second pass. The next step is compositing the polygon colour with the colour already present in the same location in the back buffer. The filled polygon is added to the back buffer one pixel at a time. Only the relevant pixels of the back buffer (those covered by the polygon) are composited with the edge buffer.

Once one polygon is stored in the back buffer, the process then returns to read in the next polygon as described above. The next polygon, which is in front of the previous polygon, is composited into the back buffer in its turn. Once all the polygons have been drawn, the image is transferred from the back buffer to the front buffer, which may be, for example, in the source driver IC of an LCD display.

The Edge Buffer

The edge buffer shown in FIG. 3 is of reduced size for explanatory purposes, and is for 30 pixels (6×5) of the display. It has a sub-pixel grid of 4×4 sub-pixels (16 bits) corresponding to each pixel of the display. Only one bit is required per sub-pixel, which takes the value unset (by default) or set.

The dotted line 20 represents the edges of the polygon to be drawn from the commands shown below.
Move To (12,0)
Line To (20, 19)
Line To (0, 7)
Line To (12,0)
Move To (11, 4)
Line To (13, 12)
Line To (6, 8)
Line To (11, 4)
Fill (black)

The command language refers to the sub-pixel co-ordinates, as is customary for accurate positioning of the corners. All of the commands except the fill command are processed as part of the first pass. The fill command initiates the second pass to fill and combine the polygon to the back buffer.

FIG. 4 shows sub-pixels set for each line command. Set sub-pixels 21 are shown for illustration purposes only along the dotted line. Due to the reduced size, they cannot accurately represent sub-pixels that would be set using the commands or rules and code shown below.

The edges are drawn into the edge buffer in the order defined in the command language. For each line, the slope is calculated from the end points and then sub-pixels are set along the line. A sub-pixel may be set per clock cycle.

The following rules are used for setting sub-pixels: One sub-pixel only per horizontal line of the sub-pixel grid is set for each polygon edge. The sub-pixels are set from top to bottom (in the Y direction).

Any sub-pixels set under the line are inverted. The last sub-pixel of the line is not set (even if this means that no sub-pixels are set).

The inversion rule is to handle self-intersection of complex polygons such as in the character “X”. Without the inversion rule, the exact intersection point might have just one set sub-pixel, which would confuse the fill algorithm described later. Clearly, the necessity for the inversion rule makes it important to avoid overlapping end points of edges. Any such points would disappear, due to inversion.

To avoid such overlapping end points of consecutive lines on the same polygon the lowest sub-pixel is not set.

For example, with the command list:
Moveto(0,0)
Lineto(0, 100)
Lineto(0,200)

The first edge is effectively drawn from 0,00 to 0,99 and the second line starts from 0,100 to 0,199. The result is a solid line. Since the line is drawn from top to bottom the last sub-pixel is also the lowest sub-pixel (unless the line is perfectly horizontal, in which case, since only one sub-pixel is set for each y-value, no sub-pixels are set).

The following code section implements an algorithm for setting boundary sub-pixels according to the above rules and assumes a resolution of 176×220 pixels (as do several other code sections herein provided by way of example). The code before the “for (iy=y0+1;iy<y1;iy++)” loop is run once per edge and the code in the “for (iy=y0+1;iy<y1;iy++)” loop is run every clock cycle.

```
void edgedraw(int x0, int y0, int x1, int y1)
{
    float tmpx,tmpy;
    float step,dx,dy;
    int iy,ix;
    int bit,idx;
  // Remove non visible lines
```

| | |
|---|---|
| if ((y0==y1)) return; | // |
| Horizontal line | |
| if ((y0<0)&&(y1<0)) return; | // Out |
| top | |
| if ((x0>(176*4))&&(x1>(176*4))) return; | // Out |
| right | |
| if ((y0>(220*4))&&(y1>(220*4))) return; | // Out |
| bottom | |

```
    // Always draw from top to bottom (Y Sort)
    if (y1<y0)
    {
      tmpx=x0;x0=x1;x1=tmpx;
      tmpy=y0;y0=y1;y1=tmpy;
    }
    // Init line
    dx=x1−x0;
    dy=y1−y0;
    if (dy==0) dy=1;
    step=dx/dy;  // Calculate slope of the line
    ix=x0;
    iy=y0;
    // Bit order in sbuf (16 sub-pixels per pixel)
    // 0123
    // 4567
    // 89ab
    // cdef
    // Index= YYYYYYYXXXXXXXyyxx
    // four lsb of index used to index bits within
the unsigned short
    if (ix<0) ix=0;
    if (ix>(176*4)) ix=176*4;
    if (iy>0)
    {
      idx=((ix>>2)&511)|((iy>>2)<<9); // Integer
part
      bit=(ix&3)|(iy&3)<<2;
      sbuf[idx&262143]\hat{ }=(1<<bit);
    }
    for (iy=y0+1;iy<y1;iy++)
    {
      if (iy<0) continue;
      if (iy>220*4) continue;
      ix=x0+step*(iy−y0);
      if (ix<0) ix=0;
      if (ix>(176*4)) ix=176*4;
      idx=((ix>>2)&511)|((iy>>2)<<9); // Integer
part
      bit=(ix&3)|(iy&3)<<2;
      sbuf[idx&262143]\hat{ }=(1<<bit);
    }
}
```

Whilst sequential drawing of the edges has been described, the skilled person will readily appreciate that some parallel processing may be implemented. For example, two or more edges of the same polygon may be drawn into the edge buffer simultaneously. In this case, logic circuitry must be provided to ensure that any overlap between the lines is dealt with suitably. Equally, two or more polygons may be rendered in parallel, if the resultant increased processing speed outweighs the more complex logic/circuitry then required. Parallel processing may be implemented for any part of the rendering.

FIG. 5 shows the filled polygon in sub-pixel definition. The dark sub-pixels are set. It should be noted here that the filling process is carried out by filler circuitry and that there is no need to re-store the result in the edge buffer. The figure is merely a representation of the set sub-pixels sent to the next step in the process. Here, the polygon is filled by a virtual marker or pen covering a single sub-pixel and travelling across the sub-pixel grid, which pen is initially off and toggles between the off and on states each time it encounters a set sub-pixel. The pen may also cover more than one sub-pixel preferably in a line of sub-pixels (for example, four sub pixels as described in the specific hardware implementation presented below). In this case it may also be referred to as a brush. The pen moves from the left to the right in this example, one sub-pixel at a time. If the pen is up and the sub-pixel is set, then the pixel is left set and the pen sets the following pixels until it reaches another set pixel. The second set pixel is cleared and the pen remains up and continues to the right.

This method includes the boundary sub-pixels on the left of the polygon but leaves out sub-pixels on the right boundary. The reason for this is that if two adjacent polygons share the same edge, there must be consistency as to which polygon any given sub-pixel is assigned to, to avoid overlapped sub-pixels for polygons that do not mathematically overlap.

Once the polygon in the edge buffer has been filled, the sub-pixels belonging to each pixel can be amalgamated and combined into the back buffer. The coverage of each 4×4 mini-grid gives the intensity of colour. For example, the third pixel from the left in the top row of pixels has 12/16 set pixels. Its coverage is 75%.

Combination into the Back Buffer

FIG. 6a shows each pixel to be combined into the back buffer and its 4 bit (0 . . . F hex) blending factor calculated from the sub-pixels set per pixel as shown in FIG. 5. One pixel may be combined into the back buffer per clock cycle. A pixel is only combined if a coverage value is greater than 0.

The back buffer is not required to hold data for the same image portion (number of display pixels) as the edge buffer. Either can hold data for the full display or part thereof. For earlier processing, however, the size of one should be a multiple of the other. In one preferred implementation, both the edge and back buffer hold data for the full display.

The resolution of the polygon in the back buffer is one quarter of its size in the edge buffer in this example (this depends, of course, on the number of sub-pixels per pixel, which can be selected according to the anti-aliasing required and other factors). The benefit of the two-pass method and amalgamation before storage of the polygon in the back buffer is that the total amount of memory required is significantly reduced. The edge buffer requires 1 bit per sub-pixel for the set and unset values. However, the back buffer requires more bits per pixel (16 here) to represent the shade to be displayed and, if the back buffer were used to set boundary sub-pixels and fill the resultant polygons, the amount of memory required would be eight times greater than the combination of the edge and back buffers, that is, sixteen 16 bit buffers would be required, rather than two.

In combination, the factors of number of sub-pixels per pixel, bits required for colour values and the proportion of the display held by the edge and back buffers means that the edge buffer memory requirement is usually smaller than or equal to that of the back buffer and the memory requirement of the front buffer is greater than or equal to that of the back buffer.

Edge Buffer Memory Requirement Compression to 8 Bits

The edge buffer is described above as having a 16 bit value organized as 4×4 bits. An alternative (“chequer board”) arrangement reduces the memory required by 50% by lowering the edge buffer data per pixel to 8 bits.

This is accomplished by removing odd XY locations from the 4×4 layout for a single display pixel as shown in FIG. 6b.

If a sub-pixel to be drawn to the edge buffer has coordinates that belong to a location without bit storage, it is moved one step to the right. For example, the top right sub-pixel in the partial grid shown above is shifted to the partial grid for the next display pixel to the right. In one specific example, the following code line may be added to the code shown above.

if ((LSB(X) xor LSB(Y))==1) X=X+1; //LSB( ) returns the lowest bit of a coordinate

This leaves only eight locations inside the 4×4 layout that can receive sub-pixels. These locations are packed to 8 bit data and stored to the edge buffer as before.

The 8 bit per pixel edge buffer is an alternative to the 16 bit per pixel buffer. Although antialiasing quality drops, the effect is small, so the benefit of 50% less memory required may outweigh this disadvantage.

Rendering of Curves

FIGS. 7a and 7b show a quadratic and a cubic bezier curve respectively. Both are always symmetrical for a symmetrical control point arrangement. Polygon drawing of such curves is effected by splitting the curve into short line segments (tessellation). The curve data is sent as vector graphics commands to the graphics engine. Tessellation in the graphics engine, rather than in the CPU reduces the amount of data sent to the display module per polygon. A quadratic bezier curve as shown in FIG. 7a has three control points. It can be defined as Moveto(x1,y1),CurveQto(x2,y2,x3,y3).

A cubic bezier curve always passes through the end points and is tangent to the line between the last two and first two control points. A cubic curve can be defined as Moveto(x1,y1),CurveCto(x2,y2,x3,y3,x4,y4).

The following code shows two functions. Each function is called N times during the tessellation process, where N is the number of line segments produces. Function Bezier3 is used for quadratic curves and Bezier4 for cubic curves. Input values p1-p4 are control points and mu is a value increasing from 0 to 1 during the tessellation process. Value 0 in mu returns p1, and value 1 in mu returns the last control point.

```
XY Bezier3(XY p1,XY p2,XY p3,double mu)
{
  double mum1,mum12,mu2;
  XY p;
  mu2 = mu * mu;
  mum1 = 1 − mu;
  mum12 = mum1 * mum1;
  p.x = p1.x * mum12 + 2 * p2.x * mum1 * mu + p3.x
* mu2;
  p.y = p1.y * mum12 + 2 * p2.y * mum1 * mu + p3.y
* mu2;
  return(p);
}
XY Bezier4(XY p1,XY p2,XY p3,XY p4,double mu)
{
  double mum1,mum13, mu3;
  XY p;
  mum1 = 1 − mu;
  mum13 = mum1 * mum1 * mum1;
  mu3 = mu * mu * mu;
  p.x = mum13*p1.x + 3*mu*mum1*mum1*p2.x +
3*mu*mu*mum1*p3.x + mu3*p4.x;
  p.y = mum13*p1.y + 3*mu*mum1*mum1*p2.y +
3*mu*mu*mum1*p3.y + mu3*p4.y;
  return(p);
}
```

The following code is an example of how to tessellate a quadratic bezier curve defined by three control points (sx,sy), (x0,y0) and (x1,y1). The tessellation counter x starts from one, because if it were zero the function would return the first control point, resulting in a line of zero length.

```
  XY  p1,p2,p3;
  p1.x = sx;
  p1.y = sy;
  p2.x = x0;
  p2.y = y0;
  p3.x = x1;
  p3.y = y1;
  #define split 8
  for(x=1;x<=split;x++)
  {
    p=Bezier3(p1,p2,p3, x/split);  // Calculate
next point on curve path
    LineTo(p.x,p.y);  // Send LineTo
  command to Edge Draw unit
  }
```

FIG. 8 shows the curve tessellation process defined in the above code sections and returns N line segments. The central loop repeats for each line segment.

Fill Types

The colour of the polygon defined in the high-level language may be solid; that is, one constant RGBA (red, green, blue, alpha) value for the whole polygon or may have a radial or linear gradient.

A gradient can have up to eight control points. Colours are interpolated between the control points to create the colour ramp. Each control point is defined by a ratio and an RGBA colour. The ratio determines the position of the control point in the gradient, the RGBA value determines its colour.

Whatever the fill type, the colour of each pixel is calculated during the blending process when the filled polygon is combined into the back buffer. The radial and linear gradient types merely require more complex processing to incorporate the position of each individual pixel along the colour ramp.

FIG. 9 gives four examples of linear and radial gradients. All these can be freely used with the graphics engine of the invention.

FIG. 10 shows a standard gradient square. All gradients are defined in a standard space called the gradient square. The gradient square is centered at (0,0), and extends from (−16384,−16384) to (16384,16384).

In FIG. 10 a linear gradient is mapped onto a circle 4096 units in diameter, and centered at (2048,2048). The 2×3 Matrix required for this mapping is:

| | |
|---|---|
| 0.125 | 0.000 |
| 0.000 | 0.125 |
| 2048.000 | 2048.000 |

That is, the gradient is scaled to one-eight of its original size (32768/4096=8), and translated to (2048, 2048).

FIG. 11 shows a hairline 23 to be drawn in the edge buffer. A hairline is a straight line that has a width of one pixel. The graphics engine supports rendering of hairlines in a special mode. When the hairline mode is on, the edge draw unit does not apply the four special rules described for normal edge drawing. Also, the content of the edge buffer is handled differently. The hairlines are drawn to the edge buffer while doing the fill operation on the fly. That is, there is no separate fill operation. So, once all the hair lines are drawn for the current drawing primitive (polygon silhouette for example), each pixel in the edge buffer contains filled sub-pixels ready for the scanline filler to calculate the set sub pixels for coverage information and do the normal colour operations for the pixel (blending to the back buffer). The line stepping algorithm used here is a standard and well known Bresenham line algorithm with the stepping on sub pixel level.

For each step a 4×4 pixel image 24 of a solid circle is drawn (with an OR operation) to the edge buffer. This is the darker shape shown in FIG. 11. As the offset of this 4×4 sub pixel shape does not always align exactly with the 4×4 sub pixels in the edge buffer, it may be necessary to use up to four read-modify-write cycles to the edge buffer where the data is bit shifted in X and Y direction to correct position.

The logic implementing the Bresenham algorithm is very simple, and may be provided as a separate block inside the edge draw unit. It will be idle in the normal polygon rendering operation.

FIG. 12 shows the original circle shape, and its shifted position. The left-hand image shows the 4×4 sub pixel shape used to “paint” the line in to the edge buffer. On the right is an example of the shifted bitmap of three steps right and two steps down. Four memory accesses are necessary to draw the full shape in to the memory.

The same concept could be used to draw lines with width of more than one pixel but efficiency would drop dramatically as the overlapping areas of the shapes with earlier drawn shapes would be bigger.

FIG. 13 shows the final content of the edge buffer, with the sub-pixel hairline 25 which has been drawn and filled simultaneously as explained above. The next steps are amalgamation and combination into the back buffer.

The following is a generic example of the Bresenham line algorithm available on the Internet implemented in Pascal language. The code starting with the comment “{Draw the Pixels}” is run each clock cycle, and the remaining code once per line of sub-pixels.

| procedure Line(x1, y1, x2, y2 : integer; color : | |
|---|---|
| byte); | |
| var | i, deltax, deltay, numpixels, |
| | d, dinc1, dinc2, |
| | x, xinc1, xinc2, |
| | y, yinc1, yinc2 : integer; |

```
begin
  { Calculate deltax and deltay for initialisation }
  deltax := abs(x2 − x1);
  deltay := abs(y2 − y1);
  { Initialize all vars based on which is the
independent variable }
  if deltax >= deltay then
    begin
      { x is independent variable }
      numpixels := deltax + 1;
      d := (2 * deltay) − deltax;
      dinc1 := deltay Shl 1;
      dinc2 := (deltay − deltax) shl 1;
      xinc1 := 1;
      xinc2 := 1;
      yinc1 := 0;
      yinc2 := 1;
    end
  else
    begin
      { y is independent variable }
      numpixels := deltay + 1;
      d := (2 * deltax) − deltay;
      dinc1 := deltax Shl 1;
      dinc2 := (deltax − deltay) shl 1;
      xinc1 := 0;
      xinc2 := 1;
      yinc1 := 1;
      yinc2 := 1;
    end;
  { Make sure x and y move in the right directions }
  if x1 > x2 then
    begin
      xinc1 := − xinc1;
      xinc2 := − xinc2;
    end;
  if y1 > y2 then
    begin
      yinc1 := − yinc1;
      yinc2 := − yinc2;
    end;
  { Start drawing at }
  x := x1;
  y := y1;
  { Draw the pixels }
  for i := 1 to numpixels do
    begin
      PutPixel(x, y, color);
      if d < 0 then
        begin
          d := d + dinc1;
          x := x + xinc1;
          y := y + yinc1;
        end
      else
        begin
          d := d + dinc2;
          x := x + xinc2;
          y := y + yinc2;
        end;
    end;
end;
```

Back Buffer Size

The back buffer in which all the polygons are stored before transfer to the display module is ideally the same size as the front buffer (and has display module resolution, that is, one pixel of the back buffer at any time always corresponds to one pixel of the display). But in some configurations it is not possible to have a full size back buffer for size/cost reasons.

The size of the back buffer can be chosen prior to the hardware implementation. It is always the same size or smaller than the front buffer. If it is smaller, it normally corresponds to the entire display width, but a section of the display height, as shown in FIG. 14. In this case, the edge buffer 13 need not be of the same size as the front buffer. It is required, in any case, to have one sub-pixel grid of the edge buffer per pixel of the back buffer.

If the back buffer 15 is smaller than the front buffer 17 as in FIG. 14, the rendering operation is done in multiple external passes. This means that the software running, for example, on host CPU must re-send at least some of the data to the graphics engine, increasing the total amount of data being transferred for the same resulting image.

The FIG. 14 example shows a back buffer 15 that is ⅓ of the front buffer 17 in the vertical direction. In the example, only one triangle is rendered. The triangle is rendered in three passes, filling the front buffer in three steps. It is important that everything in the part of the image in the back buffer is rendered completely before the back buffer is copied to the front buffer. So, regardless of the complexity of the final image (number of polygons), in this example configuration there would always be maximum of three image transfers from the back buffer to the front buffer.

The full database in the host application containing all the moveto, lineto, curveto commands does not have to be sent three times to the graphics engine. Only commands which are within the current region of the image, or commands that cross the top or bottom edge of the current region are needed. Thus, in the FIG. 14 example, there is no need to send the lineto command which defines bottom left edge of the triangle for the top region, because it does not touch the first (top) region. In the second region all three lineto commands must be sent as all lines touch the region. And in the third region, the line to on top left of the triangle does not have to be transferred.

Clearly, the end result would be correct without this selection of code to be sent but selection reduces the bandwidth requirement between the CPU and the graphics engine. For example, in an application that renders a lot of text on the screen, a quick check of the bounding box of each text string to be rendered will result in fast rejection of many rendering commands.

Sprites

Now that the concept of the smaller size back buffer and its transfer to the front buffer has been illustrated, it is easy to understand how a similar process can be used for rendering of 2D or 3D graphics or sprites. A sprite is a usually moving image, such as a character in a game or an icon. The sprite is a complete entity that is transferred to the front buffer at a defined location. Thus, where the back buffer is smaller than the front buffer, the back buffer content in each pass can be considered as one 2D sprite.

The content of the sprite can be either rendered with polygons, or by simply transferring a bitmap from the CPU. By having configurable width, height and XY offset to indicate which part of the back buffer is transferred to which XY location in the front buffer, 2D sprites can be transferred to the front buffer.

The FIG. 14 example is in fact rendering three sprites to the front buffer where the size of the sprite is full back buffer, and offset of the destination is moved from top to bottom to cover the full front buffer. Also the content of the sprite (back buffer) is rendered between the image transfers.

FIG. 15 shows one sprite in the back buffer copied to two locations in the front buffer. Since the width, height and XY offset of the sprite can be configured, it is also possible to store multiple different sprites in the back buffer, and draw them to any location in front buffer in any order, and also multiple times without the need to upload the sprite bitmap from the host to the graphics engine. One practical example of such operation would be to store small bitmaps of each character of a font set in the back buffer. It would then be possible to draw bitmapped text/fonts in to the front buffer by issuing image transfer commands from CPU, where the XY offset of the source (back buffer) is defined for each letter.

FIG. 16 shows an example in which hundreds of small 2D sprites are rendered to simulate a spray of small particles.

Low Power Mode

In addition to disabling the clock, there is a further lcd power saving mode that allows a graphics device to run as herein described but reduces the power consumption of the lcd display by reducing the colour resolution to 3 bits per pixel. For each pixel, the red, green and blue components are either on or off. This is much more power efficient (for the lcd dislay). However, if the colours are simply clamped to “0” or “1”, the display quality is very poor. To improve this, dithering is used.

The principle of dithering is well known and is used in many graphics devices. It is often used where the available colour precision (e.g. m bits per colour) is higher than can be displayed (e.g. n bits per colour). It does this by introducing some randomness into the colour value.

A random number generator is used to produce an (m-n) bit unsigned random number. This is then added to the original m-bit colour value and the top n-bits are fed to the display.

In one simple embodiment the random number is a pseudo-random number generated from selected bits of the pixel address.

Hardware Implementation of the Graphics Engine

One generalised hardware implementation has been implemented as shown in FIG. 17. The figure shows a more detailed block diagram of the internal units of the implementation.

The edge drawing circuitry is formed by the edge draw units shown in FIG. 17, together with the edge buffer memory controller.

The filler circuitry is shown as the scanline filler, with the virtual pen and amalgamation logic (for amalgamation of the sub-pixels into corresponding pixels) in the mask generator unit. The back buffer memory controller combines the amalgamated pixel into the back buffer.

A ‘clipper’ mechanism is used for removing non visible lines in this hardware implementation. Its purpose is to clip polygon edges so that their end points are always within the screen area while maintaining the slope and position of the line. This is basically a performance optimisation block and its function may be implemented as the following four if clauses in the edgedraw function:
if (iy<0) continue;
if (iy>220*4) continue;
if (ix<0) ix=0;
if (ix>(176*4)) ix=176*4;

If both end points are outside the display screen area to the same side, the edge is not processed; otherwise, for any end points outside the screen area, the clipper calculates where the edge crosses onto the screen and processes the “visible” part of the edge from the crossing point only.

In hardware it makes more sense to clip the end points as described above rather than reject individual sub-pixels, because if the edge is very long and goes far outside of the screen, the hardware would spend many clock cycles not producing usable sub-pixels. These clock cycles are better spent in clipping.

The fill traverse unit reads data from the edge buffer and sends the incoming data to the mask generator. The fill traverse need not step across the entire sub-pixel grid. For example it may simply process all the pixels belonging to a rectangle (bounding box) enclosing the complete polygon. The guarantees that the mask generator receives all the sub-pixels of the polygon. In some cases this bounding box may be far from the optimal traverse pattern. Ideally the fill traverse unit should omit sub-pixels that are outside of the polygon. There are number of ways to add intelligence to the fill traverse unit to avoid such reading empty sub-pixels from the edge buffer. One example of such an optimisation is to store the left-most and right-most sub-pixel sent to the edge buffer for each scanline (or horizontal line of sub-pixels) and then traverse only between these left and right extremes.

The mask generator unit simply contains the “virtual pen” for the fill operation of incoming edge buffer sub-pixels and logic to calculate the resulting coverage. This data is then sent to back buffer memory controller for combinating to the back buffer (colour blending).

The following table shows approximate gate counts of various units inside the graphics engine and comments relating to the earlier description where appropriate.

| | Gate | |
|---|---|---|
| Unit Name | count | Comment |
| Input fifo | 3000 | Preferably implemented as |
| | | RAM |
| Tesselator | 5000-8000 | Curve tesselator as |
| | | described above |
| Control | 1400 | |
| Ysort & Slope | 6500 | As start of edge draw code |
| divide | | section above |
| Fifo | 3300 | Makes Sort and Clipper work |
| | | in parallel. |
| Clipper | 8000 | Removes edges that are |
| | | outside the screen |
| Edge traverse | 1300 | Steps across the sub-pixel |
| | | grid to set appropriate |
| | | sub-pixels. |
| Fill traverse | 2200 | Bounding box traverse. More |
| | | gates required when |
| | | optimised to skip non |
| | | covered areas. |
| Mask generator | 1100 | More gates required when |
| | | linear and radial gradient |
| | | logic added |
| Edge buffer | 2800 | Includes last data cache |
| memory | | |
| controller | | |
| Back buffer | 4200 | Includes alpha blending |
| memory | | |
| controller | | |
| TOTAL | ˜40000 | |

Specific Silicon Implementation

A more specific hardware implementation designed to optimise silicon usage and reduce memory requirements is shown in FIG. 18. In this example, the whole process has memory requirements reduced by 50% by use of alternate (“chequer board”) positions only in the buffers, as described above and shown in FIG. 6b. Alternatively, the whole process could use all the sub-pixel locations.

Each box in FIG. 18 represents a silicon block, the boxes to the left of the edge buffer being used in the 15 first pass (tessellation and line drawing) and the boxes to the right of the edge buffer being used in the second pass (filling the polygon colour). The following text describes each block separately in terms of inputs, outputs and function. The tessellation function is not described specifically.

Sub Pixel Setter

This block sets sub-pixels defining the polygon edges, generally as described above.

Inputs

High level graphics commands, such as move to and line to commands.

Outputs

Coordinates of sub pixels on the edges of a polygon.

Function

The edge draw unit first checks each line to see if it needs to be clipped according to the screen size. If it is, it is passed to the clip unit and the edge draw unit waits for the clipped lines to be returned.

Each line or line segment is then rasterised. The rasterisation generates a sub-pixel for each horizontal sub-pixel scan line according to the rasterisation rules set out above.

Clip Unit

This block clips or “diverts” lines that cannot or are not to be shown on the final display image.

Inputs

Lines that need to be clipped (e.g. outside the screen area or desired area of view).

Outputs

Clipped lines.

Function

The clip unit clips incoming line segments outside the desired viewing area, usually the screen area. As shown in FIG. 19 if the line crosses sides B, C or D of the screen then the portion of the line outside the screen area is removed. In contrast, if a line crosses side A, then the section outside the screen area is projected onto side A by setting the x coordinate to zero for the points. This makes sure that a pseudo-edge is available from which filling starts in the second pass, since there must be a trigger for the left to right filling to begin. Whenever a clip operation is performed, new line segments with new vertices are computed and sent back to the sub-pixel setter. The original line segments are not stored within the sub-pixel setter. This ensures that any errors in the clip operation do not create artifacts.

Blocking and Bounding Unit

This unit operates in two modes for process optimisation. The first mode arranges the sub-pixels into blocks for easier data handling/memory access. Once the whole polygon has been processed in this way, the second mode indicates which blocks are to be taken into consideration and which are to be ignored because they contain no data (are outside the bounding box).

Input

Coordinates of sub-pixels to be set in the edge buffer from the sub-pixel setter.

Output

Mode 0: 4×1 pixel blocks containing sub pixels to be set in the edge buffer. Each pixel contains 8 sub pixels (in the chequerboard version) so this is 32 bits in total. The x and y coordinates of the 4×1 block are also output as well as minimum and maximum values for bounding.

Mode 1: Bounding areas of polygon. This is sent row by row with output coordinates for the set sub-pixels.

Function

The blocking and bounding unit has two modes. Each polygon is first processed in mode 0. The unit then switches to mode 1 to complete the operation.

Mode 0

The unit contains a sub-pixel cache. This cache contains sub-pixels for an area 4 pixels wide by 1 pixel high plus the address. The cache initially contains zeros. If an incoming sub-pixel is within the cache, the sub-pixel value in the cache is toggled. If the sub-pixel is outside the cache the address is changed to a new position, the cache contents and address are output to the edge buffer, the cache reset to all zeros and the location in the new cache corresponding to the incoming sub-pixel is set to one.

The cache corresponds to a block location in the edge buffer. A polygon perimeter may go outside the block and re-enter, in which case the block contents are output to the edge buffer twice, once for one edge and once for the other.

As sub-pixels are input a low resolution bounding box defining a bounding area is computed. This is stored, for example, as the minimum and maximum y value, plus a table of minimum and maximum x values. Each minimum, maximum pair corresponds to a number of pixel rows. The table may be a fixed size, so for higher screen resolutions, each entry corresponds to a large number of pixel rows. The bounding box may run through the polygon if the polygon extends up to/beyond a screen edge.

Mode 1

Mode 1 picks up the whole line from the start to the end of the bounding box. The cache is flushed for the last time and then the bounding area is rasterised line by line, left to right. Here, the blocking and bounding unit outputs the (x, y) address of each 4×1 pixel block within the area and picks up the relevant edge data to be output within the block.

MMU

The MMU (memory management unit) is effectively a memory interface.

Inputs

Sub-pixel edge data from the cache of the blocking and bounding unit (mode 0).

Addresses of 4×1 blocks (mode 1)

Memory read data from the edge buffer to be sent to the fill coverage unit (described later).

Outputs

Sub-pixel edge data for the whole polygon

Memory address and write data for the edge buffer

Function

The MMU interfaces to the edge buffer memory. There are two types of memory access, corresponding to mode 0 and mode 1 of the blocking and bounding unit. In the first mode of operation (cache operation), edge sub-pixel data is exclusive-ored with the contents of the edge buffer using a read-modify-write operation (necessary, for example if two lines pass through the same block). In the second mode, the contents of the edge buffer within the bounding box are read and output to the fill-coverage unit.

Fill Coverage

This unit fills the polygon for which the edges have been stored in the edge buffer. It generates colour values; two pixels at a time.

Inputs

End of row signal from blocking and bounding unit Co-ordinates from blocking and bounding unit via MMU Edge buffer data in block

Outputs

Coverage value co-ordinates

Function

This unit converts the contents of the edge buffer to coverage values for each pixel. It does this by ‘filling’ the polygon stored in the edge buffer (although the filled polygon is not restored) and then counting the number of sub-pixels filled for each pixel as shown in FIG. 20.

A “brush” is used to perform the fill operation. This consists of 4 bits, one for each of the sub-rows in a pixel row. The fill is performed row by row. For each row, the brush is initialised to all zeros. It is then moved sub-pixel by sub-pixel across the row. In each position, if any of the sub-pixels in the edge buffer are set, the corresponding bit in the brush is toggled. In this way, each sub-pixel in the screen is defined to be “1” or “0”.

The method may work in parallel for each 4×4 sub-pixel area using a look-up table holding values for the brush bits and the sub-pixel area.

In one implementation, two whole pixels are processed on each cycle. Only the coverage value is needed, thus, colour is calculated later and the position of set sub-pixels within the sub-pixel block is no longer of importance and is effectively discarded. The coverage value is the number of sub-pixels that are set for each pixel and is in the range 0 to 8.

For each pixel row, if the brush is all zeros when the end of row is signalled, then no further pixels need to be set in that row. If the brush is not all zeros, then this represents the case where the right hand side of the polygon is outside the screen and all the pixels between the current position and the right hand side of the screen must be set (here, the bounding box will have run through the polygon as explained earlier). The fill-coverage unit then enters a mode where it continues the fill operation to the right hand side of the screen using the current brush value.

The combination of lines being clipped to the screen area, lines always being drawn top to bottom and the last pixel never being drawn means that the bottom row of sub-pixels will never be set. To prevent this causing artefacts, the second from last sub-pixel row is effectively copied into the bottom row during the fill operation.

Blend

Inputs

Pixel coordinates and coverage values from fill-coverage unit.

Colour value; this is set independently in the command stream.

Outputs

The filled polygon and anything else already in the back buffer.

Generally polygons are pre-sorted front to back for a 3D scene. This may be by conversion to Z-values in a z-buffer, for example using the painter's algorithm. The reverse order allows proper functioning of the anti-aliasing. The per-pixel coverage value is already stored in the back (or frame) buffer. Before any polygons are drawn, the coverage values in the frame buffer are reset to zero. Each time a pixel is drawn, the rgb colour values are multiplied by coverage/8 (for the chequerboard configuration) and added to colour values in the frame buffer. The coverage value is added to the coverage value in the frame buffer. The rgb values are represented by 8 bit integers so multiplication of the rgb values by ⅛ of the coverage value can result in a rounding error. To reduce the number of artifacts resulting from this, the following algorithm is used:
1. If the existing coverage value in the frame buffer is 8, the pixel is already fully covered and the new pixel is ignored.
2. If the total coverage value is less than 8, indicating that the pixel is not fully covered,
   colour=(colour in frame buffer+⅛×input colour)
3. If the total coverage value is 8, indicating that the pixel is now fully covered,
   colour=colour in frame buffer+max_colour_value−((1−⅛×coverage)×input colour)
4. If the total coverage value is greater than 8, the coverage value of the new pixel is reduced such that the total coverage is exactly 8 and the previous case is used.

All intermediate values are rounded down and represented as 8 bit integers.

No gamma correction for non-linear eye response or per-polygon alpha (transparency) is supported in this mode. As an addition for transparent polygons, the coverage value may be used to select one of a number of gamma values. The coverage and gamma value may then be multiplied together to give a 5-bit gamma-corrected alpha value. This alpha value is multiplied by a second per-polygon alpha value.

Rasterisation

Rasterisation is the process of converting the geometry representation into a stream of coordinates of the pixels (or sub-pixels) inside the polygon.

In the above specific silicon, rasterisation takes place in 3 stages:
1. In the sub-pixel setting unit, blocking and bounding unit mode 0 and MMU, the geometry is converted into a per sub-pixel representation and stored in the edge buffer.
2. In the blocking and bounding mode 1, the bounding area is used to do the first stage of pixel coordinate generation. It outputs the addresses of all 4×1 pixel blocks in the bounding area. Note that this can contain pixels or even 4×1 pixel blocks that are completely outside the polygon.
3. In the fill coverage unit, these 4×1 pixel blocks and the contents of the edge buffer are used to generate the coordinates of all sub-pixels that are inside the polygon.
   Location of the Graphics Engine Within an Electrical Device with a Display

The graphics engine may be linked to the display module (specifically a hardware display driver, situated on a common bus, held in the CPU (IC) or even embedded within a memory unit or elsewhere within a device. The following preferred embodiments are not intended to be limiting but show a variety of applications in which the graphics engine may be present.

Integration of the Graphics Engine into the Display Module

FIG. 21 is a schematic representation of a display module 5 including a graphics engine 1 according to an embodiment of the invention, integrated in a source IC 3 for an LCD or equivalent type display 8. The CPU 2 is shown distanced from the display module 5. There are particular advantages for the integration of the engine directly with the source driver IC. Notably, the interconnection is within the same silicon structure, making the connection much more power efficient than separate packaging. Furthermore, no special I/O buffers and control circuitry is required. Separate manufacture and testing is not required and there is minimal increase in weight and size.

The diagram shows a typical arrangement in which the source IC of the LCD display also acts as a control IC for the gate IC 4.

FIG. 22 is a schematic representation of a display module 5 including a graphics engine 1 according to an embodiment of the invention, integrated in the display module and serving two source ICs 3 for an LCD or equivalent type display. The graphics engine can be provided on a graphics engine IC to be mounted on the reverse of the display module adjacent to the display control IC. If takes up minimal extra space within the device housing and is part of the display module package.

In this example, the source IC 3 again act as controller for a gate IC 4. The CPU commands are fed into the graphics engine and divided in the engine into signals for each source IC.

FIG. 23 is a schematic representation of a display module 5 with an embedded source driver IC incorporating a graphics engine and its links to CPU, the display area and a gate driver IC. The figure shows in more detail the communication between these parts. The source IC, which is both the driver and controller IC, has a control circuit for control of the gate driver, LCD driver circuit, interface circuit and graphics accelerator. A direct link between the interface circuit and source driver (bypassing the graphics engine) allows the display to work without the graphics engine.

Further details of component blocks in the display driver IC, a TFT-type structure, addressing and timing diagram and source driver circuitry are described in the International application filed on the same date as the present application, claiming priority from GB 0210764.7 and entitled “Display driver IC, display module and electrical device incorporating a graphics engine” which is incorporated herein by reference.

Of course, the invention is in no way limited to a single display type. Many suitable display types are known to the skilled person. These all have X-Y (column/row) addressing and differ from the specific LCD implementation in the document mentioned merely in driver implementation and terminology. The invention is applicable to all LCD display types such as STN, amorphous TFT, LTPS (low temperature polysilicon) and LCoS displays. It is furthermore useful for LED base displays, such as OLED (organic LED) displays.

For example, one particular application of the invention would be in an accessory for mobile devices in the form of a remote display worn or held by the user. The display may be linked to the device by Bluetooth or a similar wireless protocol.

In many cases the mobile device itself is so small that it is not practicable (or desirable) to add a high resolution screen. In such situations, a separate near to eye (NTE) or other display, possibly on a user headset or user spectacles can be particularly advantageous.

The display could be of the LCOS type, which is suitable for wearable displays in NTE applications. NTE applications use a single LCOS display with a magnifier that is brought near to the eye to produce a magnified virtual image. A web-enabled wireless device with such a display would enable the user to view a web page as a large virtual image.

Examples of Display Variations and Traffic

Display describes resolution of the display (X*Y)

Pixels is the amount of pixels on the display (=X*Y)

16 color bits is the actual amount of data to refresh/draw full screen (assuming 16 bits to describe properties of each pixel)

FrameRate@25 Mb/s describes number of times the display may be refreshed per second assuming the data transfer rate of 25 Mbit/second

Mb/s@15 fps represents required data transfer speed to assure 15 updates/second full screen.

| | | | Frame | |
|---|---|---|---|---|
| | | 16 color | Rate | Mb/s |
| Display | Pixels | bits | @25 Mb/s | @15 fps |
| 128 × 128 | 16384 | 262144 | 95.4 | 3.9 |
| 144 × 176 | 25344 | 405504 | 61.7 | 6.1 |
| 176 × 208 | 36608 | 585728 | 42.7 | 8.8 |
| 176 × 220 | 38720 | 619520 | 40.4 | 9.3 |
| 176 × 240 | 42240 | 675840 | 37.0 | 10.1 |
| 240 × 320 | 76800 | 1228800 | 20.3 | 18.4 |
| 320 × 480 | 153600 | 2457600 | 10.2 | 36.9 |
| 480 × 640 | 307200 | 4915200 | 5.1 | 73.7 |

Examples for power consumption for different interfaces.

| | | | |
|---|---|---|---|
| CMADS i/f | @ 25 Mb/s | 0.5 mW | → 20 uW/Mb |
| CMOS i/f | @25 Mb/s | 1 mW | → 40 uW/Mb |

Hereafter 4 bus traffic examples demonstrating traffic reduction on the bus between a CPU and a dislay: (NOTE: these examples demonstrate only BUS traffic but not CPU load).

Case1: Full Screen of Kanji Text (Static)

Representing a complex situation, for the display size 176×240 resulting in 42240 pixels, or 84480 Bytes (16 bit/pixel=2 Bytes/pixel). Assuming a minimum of 16×16 pixels for a kanji character, this gives 165 kanji characters per screen. One Kanji character may in average be described in about 223 Bytes, resulting in overall amount of 36855 Bytes of data.

| | | | |
|---|---|---|---|
| Byte | 84480 | | |
| Pix | 42240 | 16 | <-- X * Y for |
| | | | one Kanji |
| Y-pix | 240 | 15 | |
| X-pix | 176 | 11 | |
| | 5 | 165 | <--- # kanji |
| | | | Full Screen |
| | Display | | |
| | | 223 | <-- |
| | | | Bytes/Kanji |
| | | | (SVG) |

| Traffic | Traffic |
|---|---|
| BitMap | SVG |
| 84480 | 36855 |

In this particular case the use of SVG accelerator would require 36 Kbyte to be transferred and for Bitmap Refresh (=refresh or draw of full screen without using accelerator) results in 84 Kbyte data to be transferred. (56% reduction).

Due to SVG basic property (Scalable) 36 Kbytes of data remains unchanged, regardless of the screen resolution, assuming the same number of characters. This is not the case in bit-mapped system, where the traffic grows proportionally with the number of pixels (X*Y).

Case2: Animated (@15fps) busy screen (165 Kanji Characters) (Display 176×240)

| | | | | | |
|---|---|---|---|---|---|
| | | 84480 | 36855 | | |
| fps | 15 | 1267200 | 552825 | bits | |
| uW | 40 | 50.7 | 22.1 | uW | for |
| | | | | | Bus |

40 represents 40 μw/mbit of data.

CPU to GE traffic is 552 kbits/s (22 uW), whereas GE to display traffic is 1267 kbits/s (50 uW)

Case3: Filled Triangle Over Full Screen

Full Screen

Bit—Map (=without accelerator) 84480 Byte data (screen 176×240, 16 bit colour),
for SVG accelerator only 16 Bytes (99.98% reduction).

Case4: Animate (@15fps) rotating filled triangle (Display 176×240)

| | | | | | |
|---|---|---|---|---|---|
| | | 84480 | 16 | | |
| fps | 15 | 1267200 | 240 | bits | |
| uW | 40 | 50.7 | 0.01 | uW | for |
| | | | | | Bus |

40 represents 40 μw/mbit of data.

CPU to GE traffic is 240 bits/s (0.01 uW), whereas GE to display traffic is 1267 kbits/s (50 uW)

This last example shows the suitability of the graphics engine for use in games such as for animated Flash^{(™Macromedia)} based Games.

The Graphics Engine on a Common Bus with Unified or Shared Memory

FIG. 24 shows a design using a bus to connect various modules, which is typical in a system-on-a-chip design. However, the same general structure may be used with an external bus between separate chips (ICs). In this example, there is a single unified memory system. The edge buffer, front buffer and back buffer all use part of this memory.

Each component typically has an area of memory allocated for its exclusive use. In addition, areas of memory may be accessible by multiple devices to allow data to be passed from one device to another.

Because of the memory is shared, only one device can access the memory during each clock cycle. Therefore some form of arbitration is used. When a unit needs to access memory, a request is sent to the arbiter. If no other units are requesting memory that cycle, the request is granted immediately, otherwise the request is granted immediately or in a subsequent cycle according to some arbitration algorithm.

The unified memory model is sometimes modified to include one or more extra memories that have a more specialized use. In most cases, the memory is still “unified” in that any module can access any part of the memory but modules will have faster access to the local memory. In the example below, the memory is split into two parts, one for all screen related functions (graphics, video) and one for other functions.

Although now shown in the figures, it is of course possible for the graphics engine to be combined into the CPU block/IC for fast communication of commands to the graphics engine.

Direct Memory Access

In a graphics operation type of system, the information to be displayed will typically be generated by the CPU. It would be possible for the CPU to pass graphics commands directly to the graphics engine but this risks stalling the CPU if the graphics device cannot process the commands fast enough. A common solution is to write the commands into an area of memory shared by the graphics unit and CPU. A Direct Memory Access unit (DMA) is then used to read these commands and send them to the graphics unit. This DMA may either be a central DMA, usable by any device or may be combined with the graphics unit.

When all the data has been sent to the graphics engine, the DMA may optionally interrupt the CPU to request more data. It is also common to have two identical areas of memory in a double buffering scheme. The graphics engine processes data from the first area while the CPU writes commands to the second. The graphics engine then reads from the second while the CPU writes new commands to the first and so on.

Use of the Graphics Engine Within a Set-Top Box Application or Games Console

For a set-top box application, the modules connected to the memory bus typically include a CPU, an mpeg decoder, a transport stream demultiplexor, smart card interface, control panel interface, PAL/NTSC encoder. Other interfaces such as a disk drive, DVD player, USB/Firewire may also be present. The graphics engine can connect to the memory bus in a similar way to the other devices as shown in FIG. 26.

FIG. 27 shows modules connected to a memory bus for a games console. The modules typically include a CPU, joystick/gamepad interface, audio, an lcd display and the graphics engine.

The Graphics Engine Embedded into Memory

The initial application section described the integration of the graphics engine into the Display-IC, which has some advantages and disadvantages depending on the customer application and situation.

As described subsequently, we also can implement the graphics engine in other areas like the base-band (which is the module in a mobile telephone or other portable device used to hold CPU and most or all of the digital and analogue processing required; it may comprise one or more ICs) or application processor or on a separate companion-IC (used in addition to the base band to hold added-value functions such as mpeg, MP3 and photo processing) or similar. The main benefit of combination with base-band processing is to reduce the cost as these ICs normally use more advanced processes. Further cost reduction comes from using UMA (Unified Memory Architecture) as this memory is already available to a large extent. So there are no additional packages, assemblies etc. required.

In the case of base-band, however, the difficulty is the limitation of memory bandwidth. In the Display-IC application this is not a problem, since the graphics engine can use embedded memory in the Display-IC, which is separated from UMA. In order to resolve memory bandwidth problems there are a number of possibilities, such as using higher bandwidth memory (DDR=Double Data Rate) or partitioning intensively used memory in the base-band as described. That mans that some memory is outside of the base-band in UMA and some intensively used memory is embedded. The benefit is lower bandwidth requirements, which must be set against the higher IC cost for the base-band (embedded memory).

Yet another problem using external UMA is random access of UMA. In case of random access memory latency renders the entire process slow and therefore not efficient. To resolve that we may add some local buffers (memory) to base-band to cache and use burst mode transfer from/to external memory. Again this has some negative impact as increased silicon size of the base-band module/IC.

FIG. 29 shows an embodiment in which the graphics engine is embedded in memory. In this case the graphics engine is held within a mobile memory (chip) already present in an electrical display device. There are many advantages to such an arrangement, especially because the graphics engine must read from and write to memory frequently due to the use of the three (edge, back and front) buffers and the two-pass method. The term mobile indicates memory particularly suitable for us with mobile devices, which is often mobile DRAM with lowered power usage and other features specific for mobile use. However, the example also applies for use with other memory, such as memory more commonly used in the PC industry.

Some of the advantages of embedding the graphics engine within the memory as are as follows:

The positioning releases memory bandwidth requirements from the CPU side (base-band side) of the architecture. The GE has local access to memory within the Mobile Memory IC. The Mobile Memory IC due to its layout architecture may have some “free” Silicon areas thus allowing low-cost integration of the GE, as otherwise these Silicon areas are not used. No or few additional pads are required since the Mobile Memory IC is receiving commands. So one (or more) commands can be used to command/control GE. This is similar to the Display-IC/legacy case. There are no additional packages on additional I/O on the base-band and additional components in the entire mobile IC (as this would be an integral part of Memory), thus there is almost no physical change of any existing (pre-acceleration) system.

Embedding the GE accommodates any additional memory demand the GE has, like a z-buffer or any super sampling buffers (in case of traditional antialiasing). The architecture can perfectly be combined with DSP to accommodate MPEG streaming and combine it with graphical interface (video in a window of graphical surround).

The embodiments mentioned above share the common feature that the graphics engine is not housed on a separate IC, but integrated in an IC or module already present and necessary for the functioning of the electrical device in question. Thus the graphics engine may be wholly held within a IC or chip set (CPU, DSP, memory, system-on-a-chip, baseband or companion IC) or even divided between two or more ICs already present.

The graphics engine in hardware form is advantageously low in gate numbers and can make use of any free silicon areas and even any free connection pads. This allows a graphics engine to be provided embedded into a memory (or other) IC, without changing the memory ICs physical interface. For example, where the graphics engine is embedded in A chip with intensive memory usage (in the CPU IC or ICs) it may be possible, as for the memory IC, to avoid any change to the physical IC interface and layout and design of the board as a whole. The graphics engine can make use of unallocated command storage within the IC to perform graphics operations.

1. A graphics engine for rendering image data for display pixels in dependence upon received high-level graphics commands defining polygons including: an edge draw unit to read in a command phrase of the language corresponding to a single polygon edge and convert the command to a spatial representation of the edge based on that command phrase.

2. A graphics engine according to claim 1 wherein the edge draw unit reads in a valid command phrase and immediately converts it to a spatial representation.

3. A graphics engine according to claim 1, wherein the spatial representation is based on that command phrase alone, except where the polygon edge overlaps edges previously or simultaneously read and converted.

4. A graphics engine according to claim 1 wherein the spatial representation of the edge is in a sub-pixel format.

5. A graphics engine according to claim 1 wherein the spatial representation defines the position of the final display pixels.

6. A graphics engine according to claim 1 further comprising an edge buffer for storage of the spatial representation.

7. A graphics engine according to claim 6 wherein the edge buffer is in the form of a grid and each individual grid square can be toggled between set and unset values.

8. A graphics engine according to claim 1 wherein the edge draw unit includes control circuitry or logic to discard the original command once converted.

9. A graphics engine according to claim 6 wherein the graphics engine includes control circuitry or logic to store sequentially the edges of the polygon read into the engine in the edge buffer.

10. A graphics engine according to claim 6 wherein the edge buffer stores each polygon edge as boundary sub-pixels which are set and whose positions in the edge buffer correspond to the edge position in the final image.

11. A graphics engine according to claim 1 wherein the input and conversion of single polygon edges allows rendering of polygons without triangulation.

12. A graphics engine according to claim 1 wherein the input and conversion of individual polygon edges allows rendering of a polygon to begin before all the edge data for the polygon has been acquired.

13. A graphics engine according to claim 1 wherein the graphics engine further includes filler circuitry or logic to fill in polygons whose edges have been stored by the edge draw unit.

14. A graphics engine according to claim 1 wherein the graphics engine includes a back buffer to store part or all of a filled-in image before transfer to a front buffer of the display memory.

15. A graphics engine according to claim 14 wherein each pixel of the back buffer is mapped to a pixel in the front buffer and the back buffer preferably has the same number of bits per pixel as the front buffer to represent the color (RGBA value) of each display pixel.

16. A graphics engine according to claim 14 wherein the graphics engine includes combination circuitry or logic to combine each filled polygon from the filler circuitry or logic into the back buffer.

17. A graphics engine according to claim 14 wherein the color of each pixel stored in the back buffer is determined in dependence on the color of the pixel in the polygon being processed, the percentage of the pixel covered by the polygon and the color already present in the corresponding pixel in the back buffer.

18. A graphics engine according to claim 6 wherein the edge buffer comprises sub-pixels in the form of a grid having a square number of sub-pixels corresponding to each display pixel.

19. A graphics engine according to claim 18 wherein every other sub-pixel in the edge buffer is not utilized, so that half the square number of sub-pixels is provided for each display pixel.

20. A graphics engine according to claim 7 wherein the slope of each polygon edge is calculated from the edge end points and then sub-pixels of the grid are set along the line.

21. A graphics engine according to claim 7 wherein the following rules are used for setting sub-pixels:
one sub-pixel only per horizontal line of the sub-pixel grid is toggled for each polygon edge;
the sub-pixels are toggled from top to bottom (in the Y direction);
the last sub-pixel of the line is not toggled;

22. A graphics engine according to claim 13 wherein the filler mechanism includes logic acting as a virtual pen traversing the sub-pixel grid, which pen is initially off and toggles between the off and on states each time it encounters a set sub-pixel.

23. A graphics engine according to claim 22 wherein the virtual pen sets all sub-pixels inside the boundary sub-pixels, and includes boundary pixels for right-hand boundaries, and clears boundary pixels for left-hand boundaries or vice versa.

24. A graphics engine according to claim 22 wherein the virtual pen covers a line of sub-pixels to fill a plurality of sub-pixels simultaneously.

25. A graphics engine according to claim 13 wherein filled sub-pixels corresponding to a display pixel are amalgamated into a single pixel before combination to the back buffer.

26. A graphics engine according to claim 25 wherein the number of sub-pixels of each amalgamated pixel covered by the filled polygon determines a blending factor for combination of the amalgamated pixel into the back buffer.

27. A graphics engine according to claim 14 wherein the back buffer is copied to the front buffer of the display memory once the image on the part of the display for which it holds information has been entirely rendered.

28. A graphics engine according to claim 14 wherein the back buffer is of the same size as the front buffer and holds information for the whole display.

29. A graphics engine according to claim 14 thereon wherein the back buffer is smaller than the front buffer and stores the information for part of the display only, the image in the front buffer being built from the back buffer in a series of external passes.

30. A graphics engine according to claim 29 wherein only commands relevant to the part of the image to be held in the back buffer are sent to the graphics engine in each external pass.

31. A graphics engine according to claim 1 wherein the graphics engine further includes a curve tessellator to divide any curved polygon edges into straight-line segments before reading and converting the resultant polygon edges.

32. A graphics engine according to claim 14 wherein the graphics engine is adapted so that the back buffer can hold one or more predetermined image elements, which are transferred to the front buffer at one or more locations determined by the high level language.

33. A graphics engine according to claim 6 wherein the graphics engine is operable in hairline mode, in which mode hairlines are stored in the edge buffer by setting sub-pixels in a bitmap and storing the bitmap in multiple locations in the edge buffer to form a line.

34. A graphics engine according to claim 1, wherein the edge draw unit can work in parallel to convert a plurality of command phrases simultaneously to spatial representation.

35. A graphics engine according to claim 1, including a dipper unit which processes any part of a polygon edge outside a desired screen viewing area before reading and converting the resultant dipped polygon edges within the screen viewing area.

36. A graphics engine according to claim 35, wherein the dipper unit deletes all edges outside the desired screen viewing area except where the edge is required to define the start of polygon filing, in which case the edge is diverted to coincide with the relevant viewing area boundary.

37. A graphics engine according to claim 1, wherein the edge draw unit includes a blocking and/or bounding unit, which reduces memory usage by grouping the spatial representation into blocks of data and/or creating a bounding corresponding to the polygon being rendered, outside of which no data is read.

38. A graphics engine according to claim 1 wherein the graphics engine is implemented in hardware and is preferably less than 100 K gates in size and more preferably less than 50 K.

39. A graphics engine according to claim 1 wherein the graphics engine is implemented in software and to be run on a processor module of an electrical device with a display.

40. An electrical device including a graphics engine as defined in claim 1, a display module, a processor module and a memory module in which high-level graphics commands are sent to the graphics engine to render image data for display pixels.

41. An electrical device according to claim 40, wherein the graphics engine is a hardware graphics engine embedded in the memory module.

42. An electrical device according to claim 40, wherein the graphics engine is a hardware graphics engine integrated in the display module.

43. An electrical device according to claim 40, wherein the graphics engine is a hardware graphics engine attended to a bus, preferably in a unified or shared memory architecture.

44. An electrical device according to claim 40 wherein the graphics engine held within a processor module or on the baseband IC or companion IC including a processor module.

45. A memory integrated circuit containing an embedded graphics engine, wherein the graphics engine uses the standard memory IC physical interface and makes use of previously unallocated command space for graphics processing.

46. A memory integrated circuit according to claim 45, wherein the graphics engine is for rendering image data for display pixels in dependence upon received high-level graphics commands defining polygons including: an edge draw unit to read in a command phrase of the language corresponding to a single polygon edge and convert the command to a spatial representation of the edge based on that command phrase.

47. An electrical device according to claim 40, wherein the device is portable.

48. An electrical device according to claim 40, wherein the device has a small-area display.
